(19) United States
(12) Patent Application Publication
(10) Pub. No.: US 2015/0012332 A1
(43) Pub. Date: Jan. 8, 2015

(54) BUSINESS TO BUSINESS TO SHARED COMMUNITIES SYSTEM AND METHOD

(71) Applicant: Caterina Papachristos, Montreal (CA)

(72) Inventor: Caterina Papachristos, Montreal (CA)

(21) Appl. No.: 14/370,764

(22) PCT Filed: May 2, 2011
(86) PCT No.: PCT/CA2011/000491

§ 371 Date: Jul. 4, 2014

Related U.S. Application Data
(60) Provisional application No. 61/433,555, filed on Jan. 18, 2011.
(60) Provisional application No. 61/433,567, filed on Jan. 18, 2011.
(60) Provisional application No. 61/433,572, filed on Jan. 18, 2011.

(51) Int. Cl. G06Q 50/00; G06Q 30/02; G06Q 30/00; G06Q 10/06

(52) U.S. Cl. CPC G06Q 50/01; G06Q 10/06311; G06Q 30/0201; G06Q 30/01
USPC 705/7.29; 705/319; 705/7.13; 705/14.4; 705/304

(57) ABSTRACT

A method and a system for providing, on one side, businesses customer communities they can manage and offer services to. An aspect of the invention is the concept of shared communities between two or more businesses (customers belonging to two or more businesses at the same time). This shared community signals a potential relationship between the businesses sharing it. The current invention captures and defines such a relationship. On the other side, it allows customers to opt for and join businesses that are relevant to them. The system includes a number of components to help businesses keep their communities active and interested such an event manager, a reward manager, a campaign manager, an aftersale manager, an address book, a social engine etc. It provides also components to the businesses that help them understand their communities such as the analytics manager. The system's structure allows the creation of embedded advanced sensor network.

### CROSS-REFERENCE TO RELATED APPLICATIONS

The present patent application claims the benefits of priority of commonly own U.S. Provisional Patent Application No. 61/433,555, entitled “Business to Business to Shared Communities System and Method”, filed at the United States Patent and Trademark Office on Jan. 18, 2011, U.S. Provisional Patent Application No. 61/433,567, entitled “Virtual Relationship Within a Business to Business to Shared Communities”, filed at the United States Patent and Trademark Office on Jan. 18, 2011, and U.S. Provisional Patent Application No. 61/433,572, entitled “Event Manager in a Business to Business to Shared Communities”, filed at the United States Patent and Trademark Office on Jan. 18, 2011. The content of all three applications is incorporated herein by reference.

### FIELD OF THE INVENTION

The present invention generally relates to the technical field of social networking. More particularly, the present invention relates to business relationships and social networking, using the advantage of a relationship between at least two or more businesses via a shared community and an event manager in a Business-to-Business to Shared Community (B2B2SC).

### BACKGROUND OF THE INVENTION

The Internet and telecommunication landscapes have undergone a remarkable transformation over the last decade. Ten years ago, only a minority of people had access to the Internet and owned a mobile phone. The Internet was mainly used to exchange emails and to browse websites. Today, nearly every household has access to high speed Internet and a large majority of people possess mobile handsets.

The Internet and the World Wide Web, have shown a rapid growth in usage with an increased number of connected consumer devices. Examples of such devices are personal computers, smart phones and other mobile devices, such as feature phones, Wi-Fi enabled PDA's, tablets and media players. It is now more a matter to choose between an entry class device or high end broadband devices such as an iPhone™, Android™, Blackberry™, Windows™ mobile phones and tablets. Over the years, new ways of using Internet have been developed, particularly with the explosion of social networking.

Businesses have followed this trend, and used the World Wide Web (WWW) to established online web sites as their storefront to promote their business, products, services and promotions. Historically, the businesses have focused their marketing efforts to their physical storefront presentation, in order to attract existing customers, as well as new window shoppers. Hence, it is a common practice to display promotions, flyers and frequently update the look of the physical storefront.

With the increasing web and Internet usage, customers are using the Internet to find products and promotions. Hence, the online storefront is becoming the main asset for a business to attract and retain customers. A well maintained web site attracts customers and increases the business revenues.

Now, one of the many challenges faced by businesses is to measure the success of the online web site and to ensure that as many customers as possible frequently return to the web site to consult or have access to new promotions and other information.

Today, social networks are used to connect users and to allow those users to exchange information between them. As of today, there are now millions of people using different social networks and being part of communities sharing common interests and relationships.

Businesses are trying to leverage on these communities and use these platforms to reach and stay connected with their customers. Typically, a business creates an account on a social network and users visit and follow the business pages. To join a business community, the users need to find the business virtual address on the social site as they cannot join based on the proximity to the business. Additionally, businesses are not aware of the current location of their customers, such as knowing if a customer is within a specific range of the business or if the customers travelling path will cross a specified range from the business. Theses location information would lead to predictive analysis of their customers' mobility patterns. Also, it is impossible for businesses to use advanced services such as real time notification of products, promotions or coupons. Right now, businesses have problem targeting nearby customers or customers having special status such as gold customers or privileged customers. Also, businesses can reach those customers by buying advertisement to a chosen social network in order to gain visibility.

However, a business is not notified of the potential business relationship with another business and has no real time information on this potential relationship. A business keeps a limited knowledge of the targeted customers and has no way of knowing whether a customer is located within a specific range of the business physical location. As a matter of fact, a business has no way to distinguish or reach new potential customers that are geographically close to a particular business location such as an outlet. Also, the businesses are generally not aware of the proximity of a premium client, even if the customer is located within the business facilities.

Additionally, no current social network site allows businesses to create relationships among themselves and to share their customer communities. Such function would provide a cross-marketing tool allowing the businesses to explore new business opportunities and enhance their relationships by co-opting and/or cross marketing.

Actually, it is almost impossible for a business to target and send promotions to the customers of another business having complementary products, services or other associations that are related to the businesses. In fact, usually, a business is not aware of such complementarity between different types of businesses. To illustrate this situation, a customer “x” in a commerce “y” would not be aware of the promotions that a nearby commerce offers on complementary products to the one bought by the customer “x”. Also, it is now impossible for a business to gain visibility by sharing potential customers with other businesses.

Hence, there is a need for system(s), process(es) and/or method(s) which will guide the businesses through the possibilities of exchanging or sharing customer communities by using cross marketing tools with other businesses. There is also a need for a working solution for providing promotions or advertisement on complementary or additional products or services to customers' mobile devices while they are shopping or visiting a commerce.

### OBJECTS OF THE INVENTION

An object of this invention is to provide a method and system for business communities sharing. The sharing of communities allows businesses to extend the concept of cross-marketing to the customers of any other business that is a member of the shared community.

Another object of this invention is to provide a system and method allowing the creation of virtual communities of customers from the businesses members of the communities and to enable the communication of promotions to the members of the virtual community.

Another object of the invention is to provide an event manager allowing members of shared communities to receive or publish promotions or advertisement to members or potential customers located within a defined range of an event.

Another object of the invention is to provide a system and method allowing the creation of a sensor network where customers can sense the proximity of businesses.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The aforesaid and other aspects of the present invention are realized by generally providing system and method to share business communities with other businesses. The system allows the creation of virtual relationships between the different members in order to provide cross-marketing tools such as promotions or advertisements pushing to and pulling from members of the communities. The system comprises an event manager that allows the pushing or pulling of promotions to members or non-members of a community of customers that are geographically located within the range of an event at specific time, such as before, during or after an event is taking place.

As used herein above and below, a business extends to include events, such as a world cup event, and any entity that desires to constitute a community around a common interest, such as, but not limited to, a library. Also, the concept of a customer extends to include the meaning of a business as the latter can join a community formed around an event. Furthermore, a customer could also signify a client program, generally a machine or a device, accessing the system. As an example, an electronic banner panel could receive events and content from the system. The concept of promotion may be extended to advertisement, coupon, video, payment transactions, communication (chat, SMS, MMS, calling, click-to-call). Additionally, herein above and below, a web site should be considered as being accessed or being accessible by a computer or any mobile device.

Throughout this document, the following concepts have the following meanings:
1. Communities: Communities in the B2B2SC system are centered on businesses or social and/or commercial events such as a World Cup competition or a Formula One race. A community is a logical component in the B2B2SC system. The B2B2SC system associates a physical location to a community which is hereinunder defined as the Logical Community Location (LCL). Also, since communities are created and centered around businesses, the terms business and business community are used interchangeably in this document.
2. Logical Community Location (LCL): A LCL is a marker representing one specific geographic location or a set of logical geographic locations. The marker may be stored as a unique identifier of a sensor in the proximity of a business or as a geographic coordinate(s). As example, a LCL may be a set of all logical geographic locations of the franchises of a store chain or the coordinates of the area of a racetrack used to hold a Formula One race event. The B2B2SC system has a mechanism if a customer is within a defined range or area covered by the LCL. This LCL information is used by the B2B2SC system to manage communities and assign roles to community actors. For example, a customer within the range or area defined by a LCL might be temporarily assigned as a member of a community during a certain time duration, even if the customer has not actively joined the community associated with the LCL.
3. Community Owner: A Community Owner is an actor having set up or organized a community. This Community Owner controls the lifespan of the community and may authorize or impose policies that allows or rejects businesses to act as Community Providers. As an example of such policy authorization or imposition for a social and/or commercial event community, the Community Owner may allow all Businesses within a certain range or area of a competing event to act as Community Providers and send out promotions to customers that are part of the communicate before, during and/or after the event.
4. Community Provider: A Community Provider represents a business promoting information, products or services to at least one community. The B2B2SC system notifies the Community Consumer when updated content or promotions are available from the Community Provider.
5. Community Consumers: The Community Consumers represents the actor receiving the promotions related to products, services and community events provided by the businesses included in a community joined by the consumer. Both businesses and customers' members of a community may act as a Community Consumer to receive notifications from the particular community. Customers that are not part of the community might still be assigned the role of a Community Consumer for a limited duration, if the customer is physically within the range or area covered by the LCL.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1A is a network graph representation of the business social network showing two dimensions of the network, the customers and the businesses.

FIG. 1B is a network graph representation of the business social network showing three dimensions of the network, the customers, the businesses and the virtual relations between the businesses.

FIG. 1C is a network graph representation of the business social network showing four dimensions of the network, the customers, the businesses, the virtual relations between the businesses and relationships between the customers.

FIG. 1D is an alternative graph representation of the business social network.

FIG. 2 is a network diagram of the business social network.

FIG. 3A is a graphical representation of a customer when not in proximity to a business.

FIG. 3B is a graphical representation of a customer being near a business physical location.

FIG. 4 is a network representation of a business to business to shared community.

FIG. 5 is a diagram representing different types of virtual relationships.

FIG. 6 is a diagram of two different virtual relationships representations between businesses communities.

FIG. 7 is a flowchart showing the realization of a virtual relationship between two businesses.

FIGS. 8A to 8C depict flows of a business to business cross marketing using the location context.

FIG. 9A is network graphical representation of an Event Manager in a B2B2SC.

FIG. 9B is a detailed view of the logical components of an Event Manager.

FIG. 10A is a network representation of an Event Manager showing an “event pushing” used to publish an event. Business invokes an interface such as an API of the B2B2SC Server to publish a promotional event. Consumers are notified of promotional event using a push mechanism of notifications.

FIG. 10B is a network representation of an Event Manager having event push mechanism to publish an event. In this figure, a business invokes an interface such as an API of the B2B2SC Server to publish a promotional event. Consumers are notified of promotional event using a pull mechanism for notifications.

FIG. 10C is a network representation of an Event Manager with a timer event function to pull a semantic event meta-data from business online websites. Consumers are notified of promotional events using a push mechanism of notifications.

FIG. 10D is a network representation of an Event Manager with a timer event function to pull a semantic event meta-data from business online websites. Consumers are notified of promotional events using a pull mechanism of notifications.

FIGS. 11A to 11I are detailed views having different life spans of promotional events scheduled for the future and show multiple businesses that send promotional events to the same communities.

FIG. 12 is an architectural view of the B2B2SC system representing different aspects of the invention, e.g. the social enterprise server, the event manager, the relationship manager and other components.

FIG. 13 represents the Social Enterprise Network (“SEN”) client used as a relay in a machine to machine mode.

FIG. 14 depicts a typical customer member application flow.

FIG. 15 depicts a typical business member application flow.

FIG. 16 depicts an example algorithm for the virtual relationship determination.

FIG. 17 depicts an example of how notify businesses about their virtual relationship.

FIG. 18 depicts example of event manager flow.

### DETAILED DESCRIPTION OF THE PREFERRED EMBODIMENT

A novel Business to Business to Shared Communities system and method will be described hereinafter. Although the invention is described in terms of specific illustrative embodiments, it is to be understood that the embodiments described herein are by way of example only and that the scope of the invention is not intended to be limited thereby.

The method described herein allows the realization of the present invention having three main aspects.
I) A social community centered around a business. A plurality of members interested in the offering of a given business may join a given business and form a community of members around it. Following the registration, the members have access to relevant information, which is relative to their interest in what the business offers, and may share or discuss their interest with other members having a common interest. The created community allows the businesses to gain access to a community comprising members truly interested in the offering of the businesses. Hence, the businesses target the members with relevant offers. The presented system comprises of an account manager and a community manager which provide the above described functions.
II) Having communities surrounding businesses and knowing that members may join or gain access to a plurality of communities at the same time increase the importance of the concept of shared community between two or more businesses. The hereinabove described concept of a virtual relationship allows the B2B2SC system to identify the potential relationships existing between at least two businesses sharing the communities. For those businesses, it represents a great opportunity to explore concrete inter-business relationships which may end up into cooperation and cross-marketing tools. The relationship manager analyses and monitors the shared communities. Using a plurality of specific triggers, such as the number of members part of the shared community or the nature of the businesses sharing the communities, etc., the B2B2SC system creates at least one virtual relationship and stores in the relationship to a data source such as a database as an index linking the two or more businesses. The higher the index is ranked, the higher is the potential of a business to enter into a concrete relationship with the other businesses. The B2B2SC system informs all the businesses of the potential relationship by sending a notification through a business web client UI or through any other messaging means, such as email or SMS.
   Reaching the communities on a timely basis and in real time is very important for businesses. Also, a customer will find important to be able to save an appointment or a reminder and to be alerted when the suitable time arrives. An alert comprises the context of the alert such as the time, a description or the location. As an example, a customer may be notified of a certain appointment at lunch time. In order to increase the loyalty and the fidelity of the customer, a coupon to a restaurant selected based on the customer preferences and any other parameters such as the location may be attached to the appointment alert. The B2B2SC system comprises an event manager which enables this function. Also, the B2B2SC system allows a business to create a campaign targeting its communities and possibly the extended community. An extended community is created using the relationship manager and the community manager. These managers allow the scheduling of an event in the event manager in order to deliver a campaign at a specific time. A campaign may be defined as an information theme wherein a central message may be communicated to community and non-community members. Typically, the campaign themes are developed in order to be used during a specific timeframe to generate a planned response from the community and non-community members. Examples of campaigns include advertisements, marketing promotions, coupons, announcements, etc. Responses to campaigns may include redeeming coupons, posting feedback to announcements, purchases, claiming/joining warranties.
III) Business can also leverage their current web servers by saving meta-data (for example in a semantic web like format) along with the current data stored on the servers, such as product catalogue by using the event manager and/or campaign manager to reach their customers (community) in a timely manner.

### Business to Business to Shared Communities System and Method

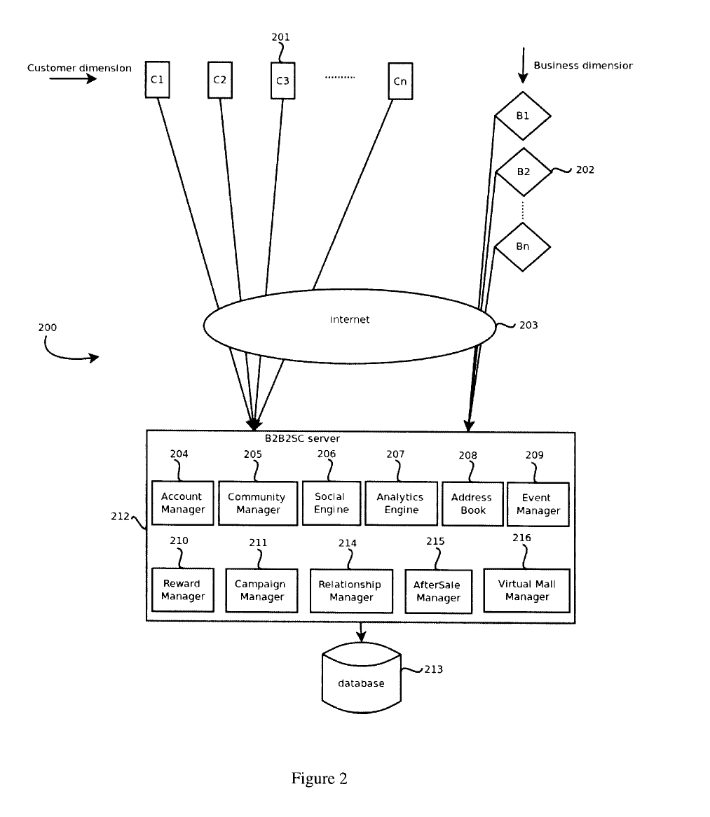

Referring to FIG. 2, a Business to Business to Shared Community (B2B2SC) is a system where businesses 202 and customers 201 can register to form and join communities. The process of joining may be performed through any user interface located on a client machine, such as a web browser, or through dedicated software running on a business's or customer's device. Upon registration with the B2B2SC system, unique identifiers are assigned respectively to the businesses 202 and customers 201 by the B2B2SC system. The customer can now start joining business communities in the B2B2SC system. The joining process can be facilitated by using a client UI. Such client UI may use Wi-Fi id detection to discover the businesses to join or GPS coordinates or any other means. In addition, any smart tag using machine to machine protocol can connect with the client UI protocol. The process may be automated by allowing the customer to express a preference that would for example tell the client when the customer is located near a certain business type that the customer would like to automatically join or at least gather those businesses in a wish to join list that the customer could process later for joining.

The B2B2SC system 200 comprises a central B2B2SC server 212. The B2B2SC server 212 may comprise one or a plurality of managers such as an account manager 204, a community manager 205, a social engine 206, an analytics engine 207, an address book 208, an event manager 209, a reward manager 210, a campaign manager 211, a relationship manager 214 and an after sale manager 215. Using the different manager components, the B2B2SC server 212 manages business and customers' accounts 204, the communities 205, the different types of relationships using the social engine 206, analytics 207, address books 208, events 209, rewards 210, campaigns 211, relationships 214, after market support 215 of the different parameters of the B2B2SC system components and actors. At least one database 213 is used to store the information required by the above components. Any distributed database or any storage system could also be used to store the required information.

The B2B2SC server 212 can comprise any combination of managers. The event manager 209 enables a business 202 to schedule events directed to their communities and indirectly to the other members separated by n-degrees of separation. In this document, the degree of separation refers to a friend of a friend relationship or more generally the contact of a contact relationship. For example, if A has B as a contact, meaning that B coordinates are part of A's address book, and B has C as a contact but A does not have C as a contact then A and C have one degree of separation.

The campaign manager 211 enables a business 202 to create at least one marketing campaign in order to reach their communities using promotions, rebates, coupons, etc.

The reward manager 210 provides rewards to the community members, such as customers 201 and businesses 202, based on the patterns of activities in the B2B2SC server 212.

The relationship manager 214 evaluates and defines the relationships between businesses 202 based on their shared communities and based on the relationships existing between the members 201 and 202 and their respective address books 208.

The address book 208 allows the members of the B2B2SC server 212 to define and import their contacts. This information can be analyzed by the B2B2SC server 212 to create a virtual relationship, which then is input to the relationship manager as valuable data.

The after sales manager 215 allows a business 202 to offer an after sale service for customer 201 by handling customer care information, such as warranties, returns, recalls and service calls, since the B2B2SC system integrates the herein above components and organizes the data around shared businesses and communities. The B2B2SC server 212 can be accessed by the community members through different interfaces located on a device or machine, such as mobile devices. The different interfaces, especially mobile devices, provide the required information to detect and analyze the communities' members' 201 and 202 behavioral patterns. The B2B2SC system 200 also helps businesses 202 increase their community members by establishing an after sale relationship with new consumers. An after-sale relationship is established based on the checked-out shopping cart product ids (or other product identifying markers). The B2B2SC system 200 stores at least one association between the customers, the purchased products and any related product information, such as warranty, expiry dates or service.

Using a combination of the hereinabove features and components, the B2B2SC system 200 allows a community member 201 to define a virtual mall. A virtual mall consists of an aggregation of the business communities of the member. The member 201 benefits from an enhanced user experience enabled by the B2B2SC system 200 through data analytics and from all the component managers outlined above. A virtual mall may help businesses attracting new members 201 by offering new rebates, coupons, promotions, rewards, group benefits, purchase methods and other revenue generating services. Also, the virtual mall helps businesses 202 establishing virtual relationships that enables cross marketing, up-selling and cross-selling of complimentary products between them.

Still referring to FIG. 2, the B2B2SC server 212 allows businesses 202 to own a community of customers 201 having relevant or common interests. The B2B2SC system 200 offers to the businesses 202 the possibility to acquire location related information of their customers, such as the proximity or the geographical position of the customer 201, and of the potential customers. A potential customer represents a customer who has not yet joined the community. In more general terms, the location information of the customers 201 is determined by the B2B2SC system.

A privacy module allows the customers 201 to configure the level of privacy towards businesses 202 associated to their profiles and information.

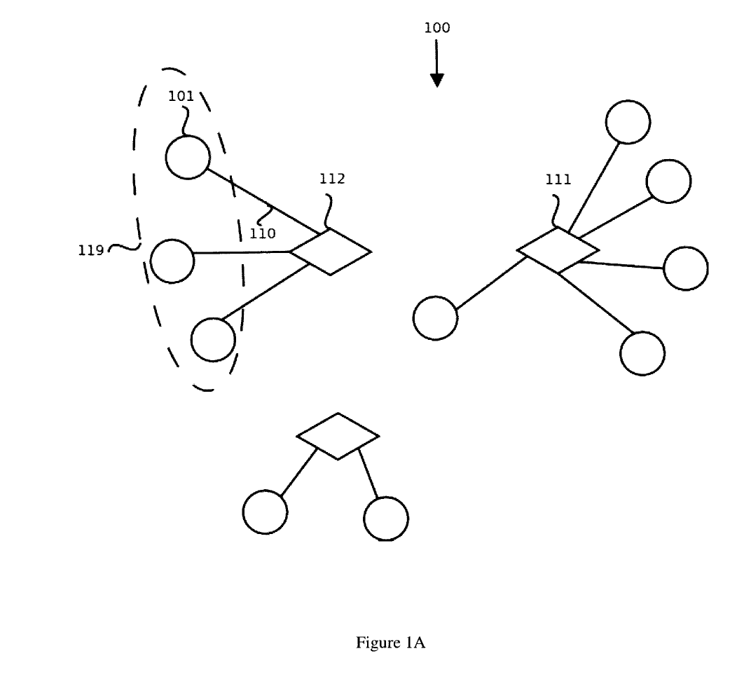

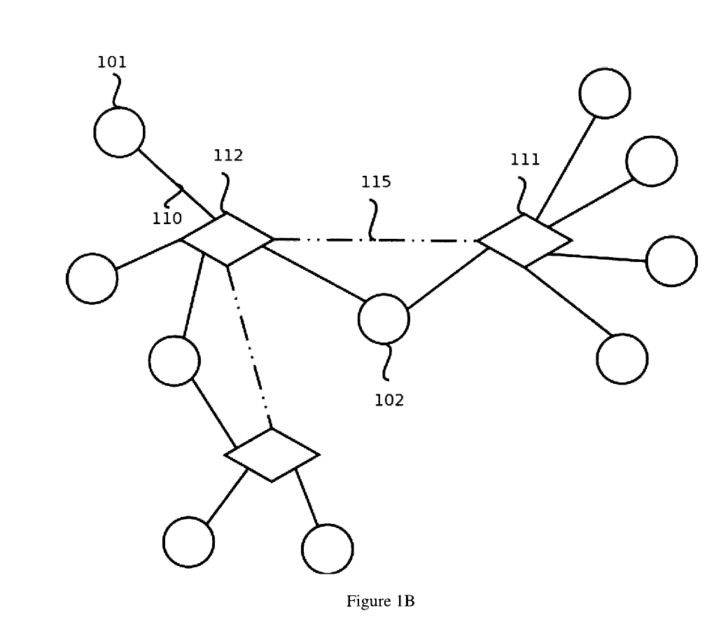

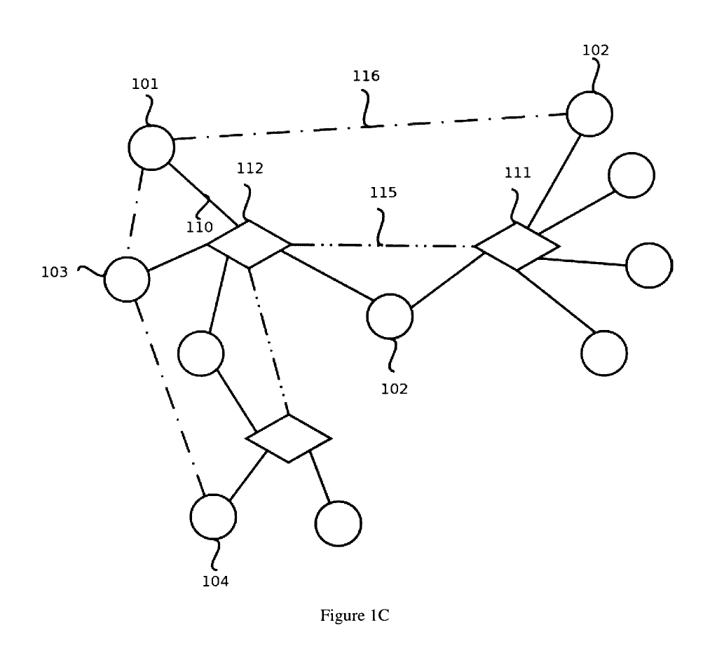

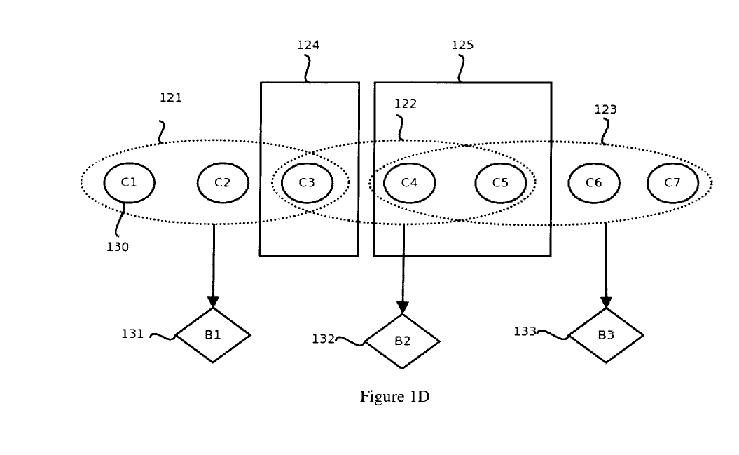

Now referring to FIGS. 1A to 1C, the three dimensions of the B2B2SC system are represented in the form of a graph, which are: the customer to business dimension 100, the business to business virtual relationship dimension 115 and the customer to customer relationship dimension 116.

Now referring to FIG. 1A, a first dimension, the customer to business dimension 100, is presented. At least one customer 101 and at least one business 111 are present in the graph. The customers 101 form communities 119 around businesses 111. The relation 110 between the customer 101 and the business 112 identifies the customer 101 as being part of the community 119 of the business 112. Hence the first dimension 100 defines businesses 112 as core nodes around which communities 119 are formed.

Now referring to FIG. 1B, the core concept of a shared customer 102 is shown. A group of shared customers 102 represents a shared community. The fact that customer 102 is present in at least two businesses communities 111 and 112, creates a virtual relationship 115 between at least two businesses 111 and 112. A relationship 115 is defined based on a number of different parameters, such as customer preferences, business domains, context of communities, environment (i.e. nice weather, winter, etc.), the B2B2SC system suggests to the businesses 111 and 112 sharing the virtual relationship 115 that they have a community in common that would be beneficial to their mutual business interests. The businesses 111 and 112 are notified using a messaging mean, such as SMS, MMS, email or instant message, or a notification through a graphical interface connected to the B2B2SC system. An entity may assist notified businesses 111 and 112 to enter into a relationship. Such assisting entity may be automated, such as a program, or be manual, such as one or more persons.

Now referring to FIG. 1C, a relationship 116 between customers 101 and 102 is shown. Such relationship is created by storing an attribute within the customer profile, the attribute pointing to a relationship object, such as a table row, describing the details of the relation. The relationship 116 may be embodied as a form of friendship, address book contacts or any social relationship defined by the customers 101, 102, 103 and 104. Businesses 111 and 112 present in the B2B2SC system are not necessarily aware of the relations 116 that exist between customers 101, 102, 103 and 104. As an example, the B2B2SC system notifies the businesses 111 and 112 that a relationship 116 exists between customers 101 and 102. As in the previous case, based on a number of parameters, such as the domain of activity of the businesses, the customer preferences (likes coffee, sport, etc.), the B2B2SC system creates and stores a compatibility profile between the businesses 111 and 112 and the customers 101, 102, 103 and 104 not included in the businesses 111 and 112 communities. For example, if two customers 101 and 102 both like coffee and every one of them have already joined a different coffee business community, say 111 and 112 are in the coffee business, and then each business 111 and 112 has the potential to extend its community based on the compatibility profile offered by the B2B2SC system. The compatibility profile is populated from the attributes of customer profiles, business profiles and/or customer preferences. As an example, in order to determine that a customer matches a business, to the B2B2SC system may compare the compatibility profile attribute defining the customer coffee preference and the attribute that defines the business domain of activity (i.e. coffee shop). Complex formulas involving more attributes could be used in order to populate the compatibility profile.

Now referring back to FIG. 1B, as another example, the business 111 and 112 are not in the same business, this extends the case of FIG. 1B with a virtual relationship between the two. It should be noted that although the description above used two businesses and two customers, it is still applicable to any number of businesses and customers.

Now referring to FIG. 1D, an alternative representation is presented. The businesses B1 131, B2 132 and B3 133 are linked to the respective communities 121, 122 and 123. The businesses B1 131 and B2 132 share a community 124, composed of customer C3, this shared customer C3 (community) triggers the B2B2SC system to watch businesses B1 and B2 for a potential relationship. Also, the businesses B2 132 and B3 133 share a community 125, composed of the customers C4 and C5. This shared community 125 also triggers a potential relationship between businesses B2 and B3.

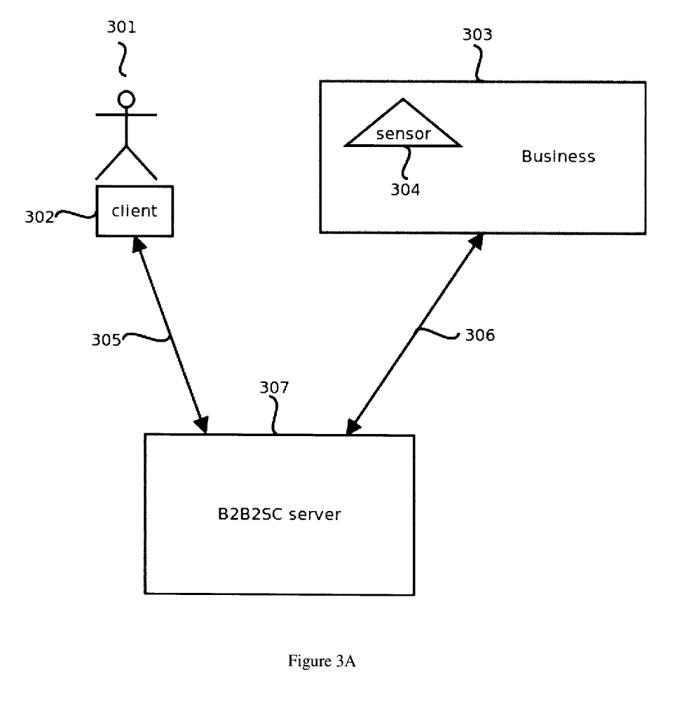

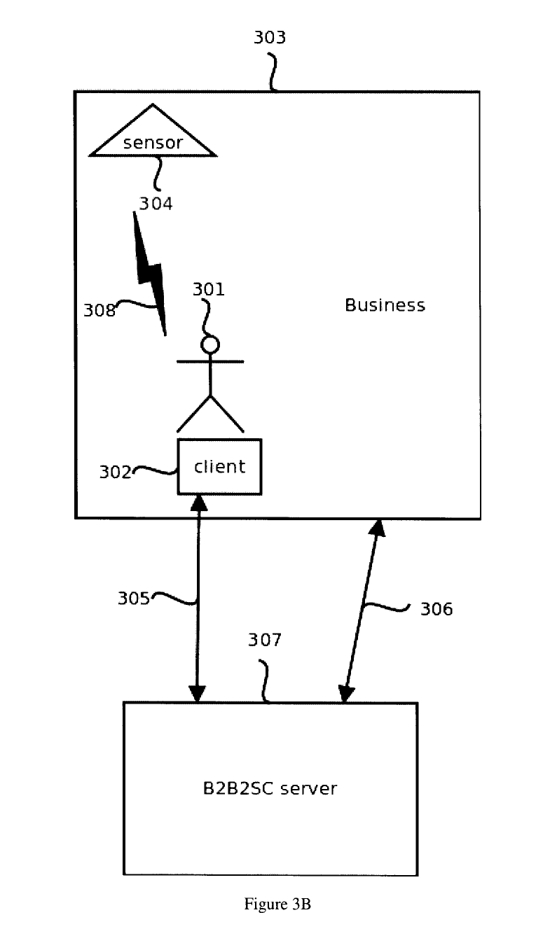

Now referring to FIG. 3A, a customer using a broadband device running a client 302 which communicates with the B2B2SC server 307. The B2B2SC server 307 comprises at least one locating mean used to determine the presence and the location proximity of a business 303. The locating mean uses location analysis tools such as GPS coordinates or different sensors 304, such as Wi-Fi, Bluetooth or other wireless technologies. The B2B2SC server 307 saves the GPS coordinates of the registered businesses 303 in the business account. The GPS coordinates may be manually entered at the registration process or may be calculated through some automated means. The automated means use a separate system to calculate the GPS coordinates of the business 303. Using the automated means enables the B2B2SC server 307 or the client device 301 to discover non-registered businesses or to locate existing or new customers.

At least one passive or active sensor 304 may be used in the business physical location 303 as a locating mean. Such sensor may make uses of communicating devices such as Wi-Fi, Bluetooth or RFID. Thereafter, a client device 301 equipped with such sensor communicating capabilities may interact with the sensor 304 located in the business physical location 303. The locating mean using a sensor may not make use of GPS coordinates, of the businesses or client physical location. The sensor locating mean only indicates the clients proximity to the business.

Now referring to FIG. 3B, the locating mean using a sensor 304 is detailed. A client 302 being close to a sensor 304 informs the B2B2SC server 307 of its presence using a sensor identifier. In the case where a wireless device is used, the sensor identifier is equal to the Basic Service Set Identifier (BSSID) which represents the Media Access Control (MAC) address of the Wi-Fi device. The B2B2SC server 307 keeps a register of the businesses registered with a sensor having this specific sensor identifier value. If the client 302 is not yet part of at least one business's 303 community, then the B2B2SC server 307 sends an invitation 305 to the client 302 to join at least one business 303 community. The sending of such invitation may depend on one or many parameters such as customer preferences or business preferences, such preferences could include but are not limited to ‘no more communities’, ‘invite new users’, ‘interested only in sports businesses’ etc. Otherwise, a client 302 member of the business 303 community may notify the B2B2SC server 307 to enable the reception of event notifications from the related business 303. The event notifications may be related to advertisement, promotion, coupon, video, payment transactions or communication such as chat, SMS, MMS, calling or click-to-call.

If the client 302 is not registered to the B2B2SC server 307, the B2B2SC server 307 sends a sign-up invitation to the client 302. The user interface located on the client 302 device will differ depending on the type of device used. On reception of such invitation, the client 302 may select the desired features, such as event notifications like coupons, advertisements, promotions, videos from the business, mobile payment or communication services, to be enabled within the B2B2SC server 307. The B2B2SC server 307 provides an interface enabling the client 302 to control the account preferences and the privacy level and options.

Virtual Relationship within a Business to Business to Shared Communities

Another aspect of the invention allows at least one business to reach new customers by sharing these customers using a B2B2SC system. The business relationships created by the B2B2SC system allow the businesses to expand their customers' communities. The B2B2SC displays to a business some of the available virtual relationships.

To illustrate the virtual relationship flow, let assume two businesses B1 and B2 are part of the B2B2SC system. Two hundred (200) customers have joined business B1 community and three hundred (300) customers have joined B2 community. One hundred (100) of those customers are part of both communities at the same time which means that B1 and B2 share 100 customers. Because of this important shared customer base, the B2B2SC system create a relationship between B1 and B2, this could be achieved by adding B1 and B2 into a relationship table stored in a database or adding a reference id to the B1 and B2 profile information that points to the relationship object (this object could contain information such as the number of shared customers, the name of the businesses involved etc.), or any other means to link B1 and B2 into a relationship. Based on businesses B1 and B2 preferences, such as the interest of a customer to be part of other businesses communities that are in a certain field, the B2B2SC system determines that a potential future relationship B1 and B2 is possible. It then sends a notification to B1 and B2 about this potential relationship. This notification could be in a form of an email, SMS or a notification on a web business UI, part of the B2B2SC system.

A virtual relationship can be the result of a critical mass of customers between two business communities. We can presume the presence of a virtual business relationship when critical masses of customers are part of two businesses communities.

A virtual business relationship can also be the result of an event such as a holiday, a specific time during the day (i.e. lunch), the weather, a dedicated calendar event, etc.

The geographical location is also a good parameter to expose a virtual business relationship when for example customers are frequently nearby an area and/or business location or when customers are leaving the area and/or business location etc. Also the geographical pattern and time of day a customer usually takes to get at the destination business can be used to expose dynamic virtual relationships that are contextual and relevant. Relevancy is based on customer preferences and behavioral patterns. As an example, in the event where a customer is heading to a hardware store and passes by a flower shop on Valentine's day, which represents the context, if the customer's preferences indicate that the customer wishes to receive discount information from the system and the current path followed by the customer is recurrent, which represents a behavioral pattern, the system will identify the hardware store and the flower shop as a virtual relationship.

Once the businesses are established in the network, the virtual relationship can be realized through different forms, such forms being defined in the followings sections.

Cross marketing can be a realization of a relationship. It could be cross selling, up selling, co-branding, etc. Cross marketing enables to target more precisely the type of company with which a business wants to share its customers. For example, a retail company that sells dresses could give access to its customers' community to a business that would sell complementary products or services such as shoes, belts, perfume, etc. Another example is a utility store could give access to coffee companies for its customers that are in the store between 8:00 AM and 11:30 AM. Since those two companies have a cross marketing relationship, they also have access to each other's customers in the virtual network.

Also, using customers broadband devices, cross marketing allows business A and B to locate the potential customers and send them the advertisement/promotion/coupon/video/payment transactions/communication (chat, SMS, MMS, calling, click-to-call . . . ), etc. when they are nearby the business location. Businesses can reach customers wherever they are but especially when they are at proximity of the businesses. If a business A shares its customers in the network with business B, both businesses could also send an advertisement/promotion/coupon/video/payment transactions/communication (chat, SMS, MMS, calling, click-to-call . . . ), etc. to potential customers that are in proximity to the other business' location.

A social event can be a relationship realization. A game with geographical goals would be a good example. The realization of the relationship will allow all the customers to be part of the same community and then send and receive instructions during the game.

It should be noted that although the descriptions above and below use two businesses and two customers, any number of businesses and customers could be used.

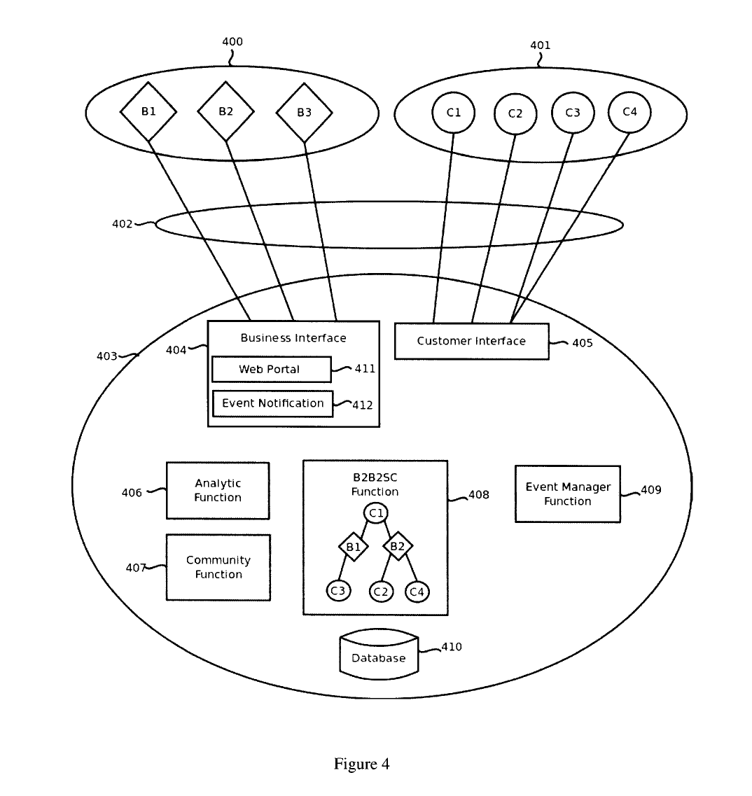

Referring to FIG. 4, a business domain 400 comprises at least one business B1, B2 or B3 that is registered to the B2B2SC 403. A customers' domain 401 comprises at least one customer C1, C2, C3 or C4 registered to the B2B2SC 403. The registered customers C1, C2, C3 or C4 can be part of one or more businesses B1, B2 and B3 400 (communities are centered around businesses). The B2B2SC server is hosted on a network of devices or computers 402, such as the Internet or a local area network, accessible by the customer device. The customer device comprises client software compatible with the B2B2SC 403 such as an internet browser, an Android™ application, an iPhone™ application or any other device being compatible with the B2B2SC server 403.

The B2B2SC server 403 connects a business B1, B2 or B3 to a customer C1, C2, C3 or C4 or a customer C1, C2, C3 or C4 to a business B1, B2 or B3.

The B2B2SC server 403 comprises a business interface module 404, a B2B2SC module 408, an event manager 409, a data source such as a database 410, a community module 407, an analytic module 406 and a customer interface module 405.

The business interface module 404 comprises at least two modules, a web portal 411 and an event notification 412 and provides the interfaces between the business domain and the B2B2SC server 403. The interfaces may include application programming interfaces (API) or web services. As an example, the B2B2SC server 403 may provide API that can be accessed by a software developed by a business to be teamed up with another business.

The web portal 411 provides to a business B1, B2 or B3 the tools to manage all their customer communities.

The event notification 412 allows the B2B2SC server 403 to notify a registered business B1, B2 or B3 of the occurrence of events such as new business's relationship opportunities. The notification can take several forms: email, SMS or a notification messages area on the business UI application (like the business's web portal), or any other communication means.

The customer interface module 405 allows a customer C1, C2, C3 and C4 to interface with a B2B2SC server 403.

The community function 407 enables any customer C1, C2, C3 and C4 or business B1, B2 or B3 to register a community identity and to subscribe to events from the community.

When a business B1, B2 or B3 registers with a B2B2SC server 403, a new business community is allocated for that particular business. Any customer registered with the B2B2SC server 403 may join one or more business communities.

A B2B2SC module 408 manages the relationship between businesses, users and the community joined by such user.

The analytic function 406 extracts the relevant business relationship opportunities from the communities stored in a B2B2SC server 403 and exposes such opportunities to all the related businesses B1, B2 or B3 registered with the B2B2SC server 403. The system uses algorithms to identify new business opportunities. Such algorithms may use the list of offered products, locations, events, purchased items as input data. As an example, on a Tuesday night clients of a book store, which are nearby a movie theater, can receive a rebate or reminder that a particular movie of an author which also wrote a book purchased from the same store.

The analytic function 406 may extract and display to a business B1, B2 or B3 one or more actions available to this business in order to add new members to one or more customer communities. The analytic function 406 may push customized promotions to customers based on specific context parameters such as location, time of the day, day, environment, holidays or calendar event. Also, the analytic function 406 can extract from the communities complimentary products between different businesses B1, B2 or B3. Nothing prevents a business from being part of another businesses' community and hence the business, similarly to customers described in this document, is a receiver of promotions, news, events or any other promotional means.

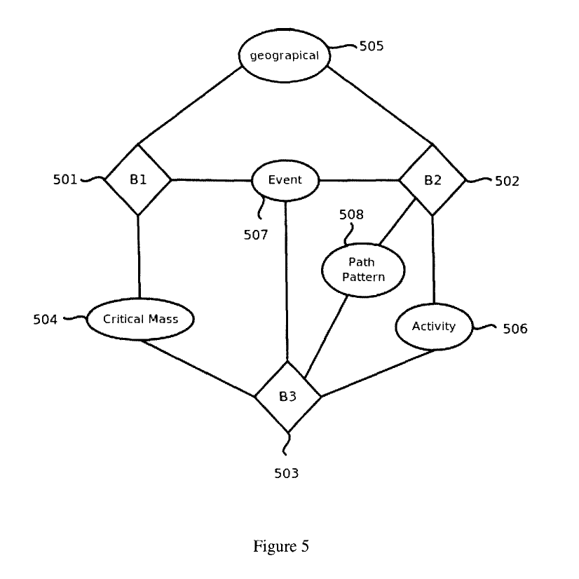

Referring now to FIG. 5, the diagram depicts different examples of virtual relationships: geographical relationship 505, critical mass of customers 504, event relationship 507, activity relationship 506 and path pattern relationship 508.

A geographical 505 relationship can be characterized by customers located in the same geographical area such as a residence community, a park, a shopping centre, a medical clinic, an educational or recreational location. A business B1, B2 or B3 being in the same geographical location may create a relationship with a customer community.

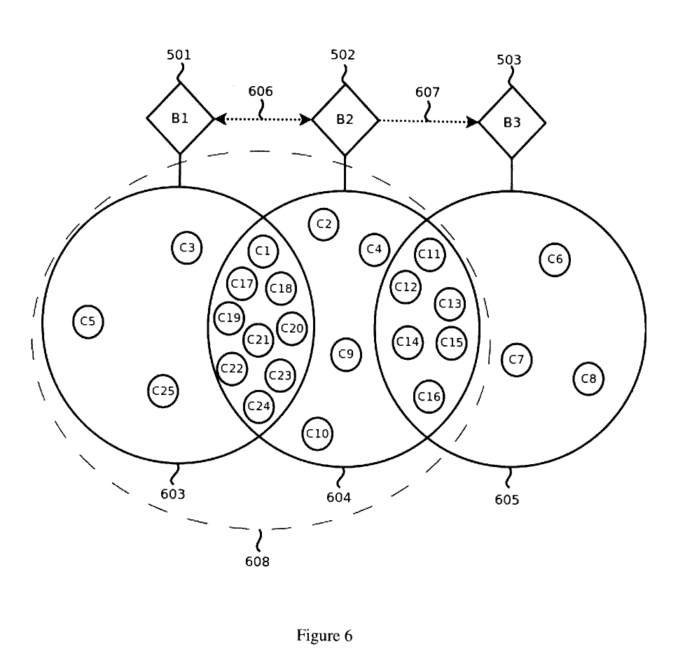

A critical mass of customers 504 represents the minimal group of customers having shopped at two or more common businesses. The minimum number can represent a configuration parameter or may be derived from an algorithm that takes into account the current number of members in the current communities, the business size (small, medium, big) and possibly a configuration parameter, such as B1 and B3, to create interest of developing a relationship between B1 and B3, such as sharing customers or providing complementary promotions or advertisement. This situation will be further detailed and explained in FIG. 6.

An event relationship 507 is described as an event that may be recurrent or punctual in time such as Holidays, a concert, a lunch with a contact, a calendar event such as a sports race or tennis tournament.

An activity relationship 506 represents a habit of a customer. For example, if a customer trains to the gym centre every week, a sports wear business may be interested to push promotions on specific sports articles. This system creates and stores at least one profile representing the habits and behaviors of a customer. For example, in the event where a customer purchases several science fiction books, the system identifies the customer as science-fiction fan and the profile could be used to offer him rebates or promotions on science-fiction movies.

A path pattern relationship 508 represents the usual itinerary or path of a customer. For example, a daily customer itinerary may be analyzed in order to create a relationship matching some special events such as Valentine's Day, Christmas or church day. For example, if a customer purchases food at his favorite supermarket on Valentine's Day, a flower store may want to send an advertisement to a customer on its way home. In order for the flower store to send an advertisement, a business relationship must have been established within the network of the related supermarket.

Referring now to FIG. 6, two different virtual relationships between businesses communities are showed. Businesses B1 500, B2 501 and B3 502 are represented with their respective customers' communities 603, 604 and 605.

The critical mass of customers (C1, C17, C18, C19, C20, C21, C22, C23, C24) between B1 and B2 customers' community 603 and 604 represents the intersecting area between the communities 603 and 604. The intersecting customers create a virtual relationship 606 between B1 and B2. The association of both communities 603 and 604 form a virtual customer community 608.

A bidirectional virtual relationship 606 represents a possible alliance between at least two businesses, in this example, business B1 500 and business B2 501. All businesses have the possibility to share their customers' community 603 604 to the other businesses of the alliance. For example, business B1 501 may push marketing events such as media, coupons, promotions, videos, payment transactions, communication such as chat, SMS, calling or click-to-call to the business B2 502 customers' communities and vice versa.

A unidirectional virtual relationship 607 represents an association from a business B2 502 to business B3 503. A unidirectional relationship 607 allows only one business B2 502 to push promotions to other businesses B3 503 customers' communities 605.

As a consequence, if several businesses share a community, they may form a virtual mall for the community members. The virtual mall is managed by the virtual mall manager system component. As a second alternative, the system allows a customer to select which stores shall be part of a virtual mall. Such created virtual mall may be published and a community around the created virtual mall may be created. From this moment, all the B2B2SC system features described in this document shall apply to this new community.

In the first alternative, the virtual mall manager creates any virtual mall based on the existence of at least one shared community between the virtual mall businesses. In order to store the virtual mall, the virtual mall manager may create a new business account within the system, wherein such account is considered as a business having the shared community as one of its communities. Consequently, all the features and functions provided by the B2B2SC system which are described in this document apply to the virtual mall. In the second alternative, the virtual mall is selected by the customer. The relationship manager uses the selection choice as an input in order to output suggestions to customers having interest in stores that are part of at least one virtual mall. Hence, the grouped stores may offer other services to the customer, such as complimentary products, group store coupons and any other group promotion. In the event where a customer wishes to publish at least one virtual mall and to engage in a social like campaign for the virtual mall, the virtual mall manager may upgrade the customer account to a business account. Such upgrading process allows the customer to manage a community similarly to a business. At least one virtual mall store may reward the customer relatively to the attraction brought to the stores through the customer's social links.

Any member of any of the shared community has access to this virtual mall through the B2B2SC system. Based on the community member's behavioral patterns and on the relationships that are created between the businesses that are part of the virtual mall, an enhanced experience is provided to the shared members. A virtual mall allows and helps businesses attracting more members and offering new rebates, coupons, promotions, rewards, group benefits, purchase methods and other revenue generating services.

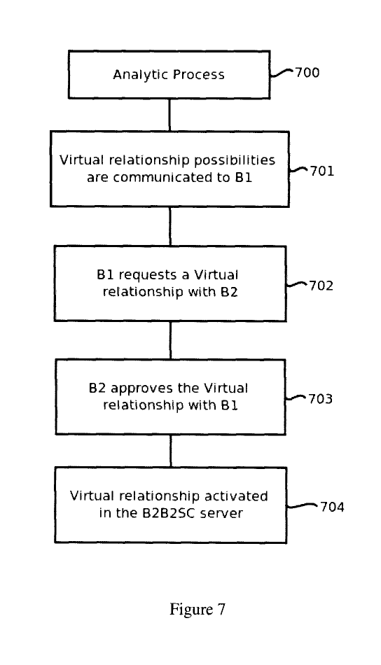

Referring now to FIGS. 4, 5 and 7, a creation process of a virtual relationship between at least two businesses is presented as a flowchart.

The analytic process 700 comprises a computer program that periodically analyzes the data source 410 to identify potential virtual relationships. Thereafter, the analytic process 700 outputs resulting potential virtual relationships related to businesses. The resulting list allows a business B1 to create business alliances between at least two businesses based on conditions and preferences such as the location, complement of products, services, different contexts such as date, time, holidays or events and also on the critical mass of common customers between the businesses communities.

The B2B2SC server 403 communicates to a business B2 the list of virtual relationship opportunities output from the analytic process 701. A web portal 411 presents B2B2SC information through a user interface that may be accessed through a log process by business 400. The web portal may act as a business community manager. As an example, the business B1 500 may, by consulting the B2B2SC web portal 411, consult the potential business relationships found by the analytic process 700 and choose a desired business community to join.

As an alternative, an event notification function 412 may push a list of potential virtual relationships to a business web portal, such as B1. The business B1 may consult and select a desired relationship to join. Then, the business B1 may request an approval 702 to one of the potential businesses comprised in the list pushed by the event notification, such as B2. The business B2 must accept the virtual relationship opportunity 703 requested by business B1 702 via a B2B2SC web portal 411. Once the request is approved by the receiving business B2 403, the B2B2SC function 108 shall create the virtual relationship 606 between a requesting business B1 and a receiving business B2. Therefore, a community of customers of consisting of both businesses B1 and B2 customers are unilaterally or bilaterally shared.

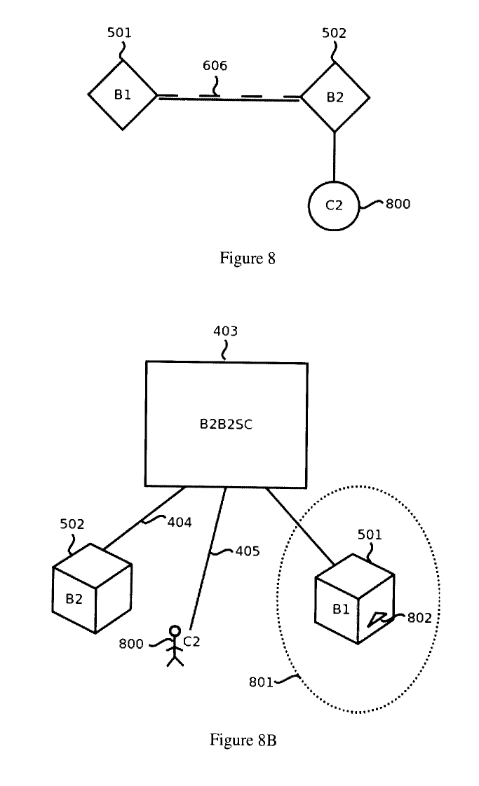

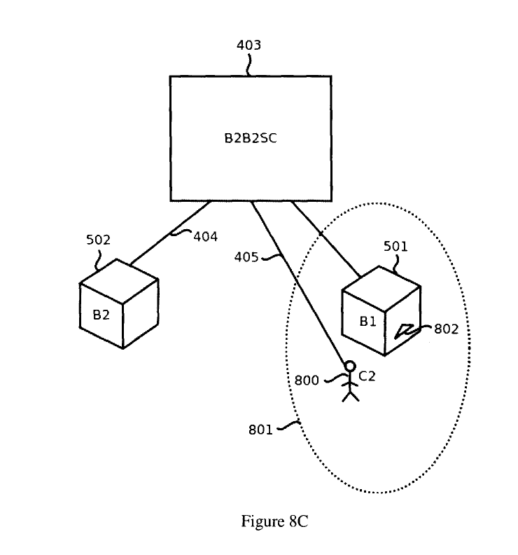

Now referring to FIGS. 8A to 8C, different flows of Business to Business Cross Marketing using the location context are depicted.

The FIG. 8A represents an embodiment of two businesses B1 500 and B2 501 related by a cross marketing relationship 606.

The customer C2 800 is a member of the business B2 community of customers. The business B1 is aware of the customer C2 through the cross marketing relationship originating from the virtual relationship created between both businesses B1 and B2.

The FIG. 8B presents the two businesses B1 and B2 geographically located within a common local zone. An initiating business such as B2 initiates a new marketing campaign using a business interface 404 served by the B2B2SC server 403. One of the objectives of a business B2 campaign may be to send marketing events such as media, advertisement, coupons, promotions, videos, possible payment transactions, communication such as chat, SMS, calling or click-to-call to other businesses customers, such as B1 customers triggered when the customers are located within the zone deserved by the business B1 outlet or when the customer purchase a product or service from the business B1. This process allows the business B2 to extend its customers network by using a cross marketing relationship defined with the business B1 through the B2B2SC server 403.

As an example of a well fitted usage of the location-based cross-marketing feature, a business selling food products and services, such as a supermarket or a local food store, may want to communicate promotions or coupons to customers located in the same mall.

FIG. 8C shows a customer C2 within a local area 501 covered by a business B1. The B2B2SC server 403 receives the customer C2 coordinates through a locating means, such as a sensor device or a GPS system, and a purchase confirmation. Upon reception of the information, the B2B2SC server 403 triggers the marketing campaign previously defined by a business B2. The B2B2SC server 403 retrieves the customer C2 location information by requesting the information to the customer locating mean such as GPS location from the customer device or a Wi-Fi SSID identification. The B2B2SC server 403 display the business B2 promotion on the customer interface 405 accessible by the customer C2 using its client device.

### Event Manager in a Business to Business to Shared Community

A Business to Business to Shared Community (B2B2SC) is a system where businesses and customers can register to form and join communities. The process of joining is performed through a user interface such as web browser or dedicated software that is downloaded to a mobile device in a business or customer possession. Upon registration with the B2B2SC, businesses and customers are assigned a unique id to identify them in the system. The B2B2SC system has a central server (B2B2SC server) that manages business, customers and the shared communities.

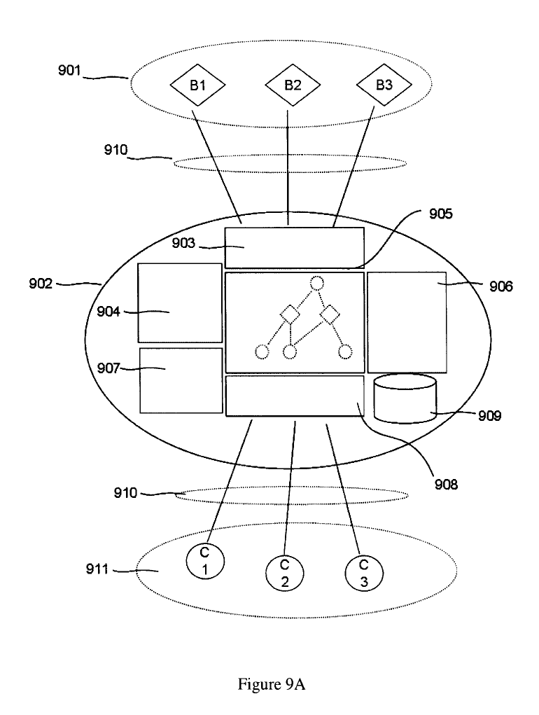

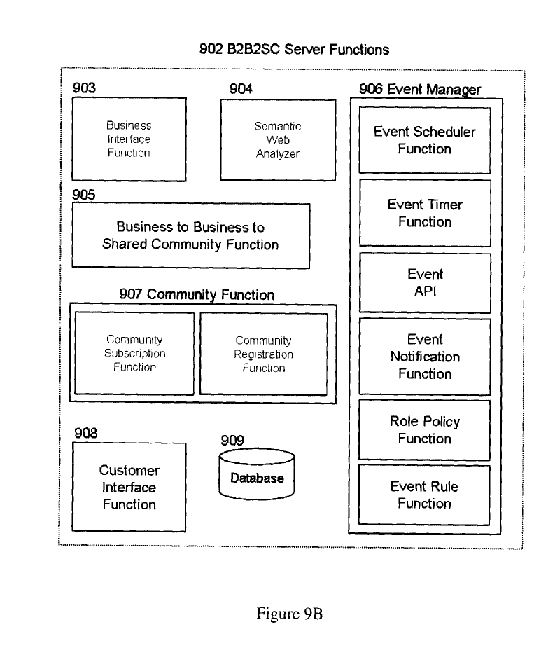

Referring to FIG. 9A, a network overview of a Business to Business to Shared Community system is presented. A business domain 901 comprises the businesses having an online website and having joined the B2B2SC system. Each individual business (n) is identified as B(n).

A central server (B2B2SC server) 902 is core to the B2B2SC system. The B2B2SC server comprises the components relevant to the event manager business interface function 903, the semantic web analyzer 904, the B2B2SC function 905, the event manager 906, the community function 907, the customer interface function 908 and a data source 909 such as a database.

The customer domain 911 includes the customers using mobile devices. C(n) represents a customer device (n) having the required software installed in order to access the functions of the shared community 902.

At least one network such as the Internet or a local area network 910 is used to connect at least one business B(n) member of a business domain 901, at least one B2B2SC server 902 and at least one customer member of the customer domain that may be located in different geographical locations.

Now referring to FIG. 9B, a detailed perspective of the components of the B2B2SC server is presented. The community function 907 allows the customers and businesses to register a community identity and to subscribe to events provided by the community.

When a business registers with the B2B2SC system 902, the system 902 creates a Business Community comprising the registering business and stores the related LCL in a data source 909 within the B2B2SC system 902. The system 902 assigns at least one role to the registering business. The assigned role may be Community Owner, Community Provider or both. Once the Business Community is created, any customer may join the Business Community and may become a Community Consumer. The B2B2SC Function 905 manages the relationship between at least one business, one consumer and the communities joined by the Community Consumer. The Event Manager 906 comprises a Rule Policy Function. The Rule Policy Function manages and authorizes the granting of the Community Provider role to a business.

A Business Interface Function 903 allows at least one business device to interface with the B2B2SC server 902 using interfaces such as event APIs or web services. A Customer Interface Function 908 enables at least one customer device to interface with the B2B2SC server 902.

A Semantic Web Analyzer 904 is a component that analyzes web content looking for semantic metadata related to events, such as promotional events. An Event Manager 906 comprises a least one Scheduling Function allowing the scheduling of future events, such as social/commercial events.

An Event Manager 906 comprises at least on Event Rule Engine component. This engine enables the B2B2SC system 902 to personalize and provide enhanced benefits and promotions to individual customers of the Community. For example, the B2B2SC system 902 may communicate or push a special promotion to an entire community during a week while the system 902 communicates or pushes an additional promotion to an individual customer located within a determined range of a store at a specific time. As another example, the B2B2SC system 902 may provide cross promotions between two communities joined by a customer.

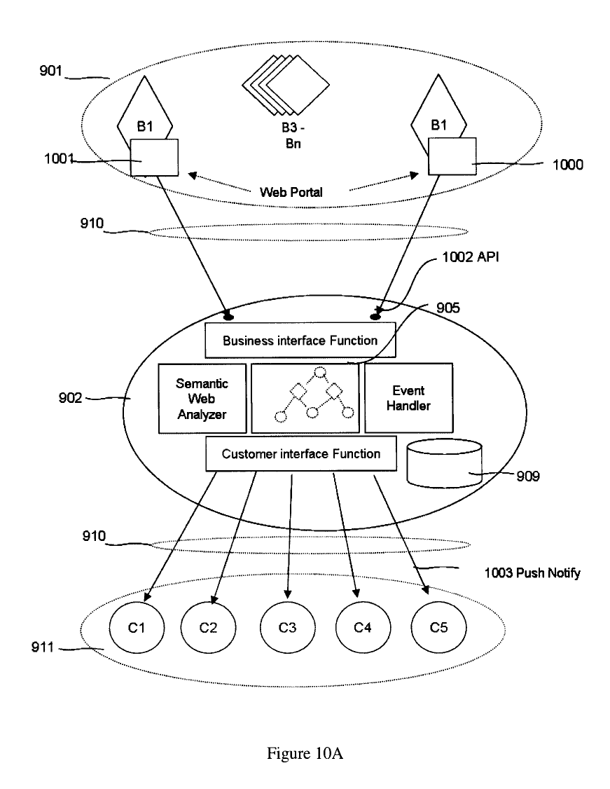

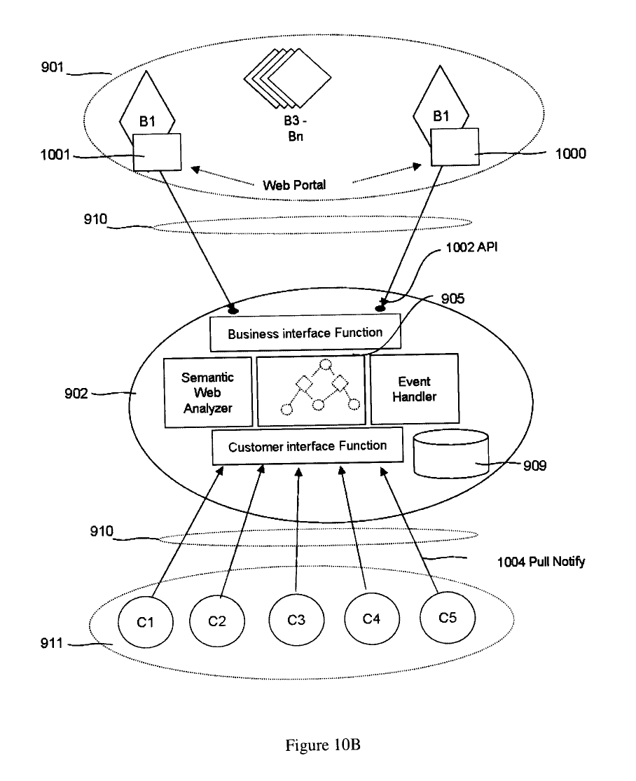

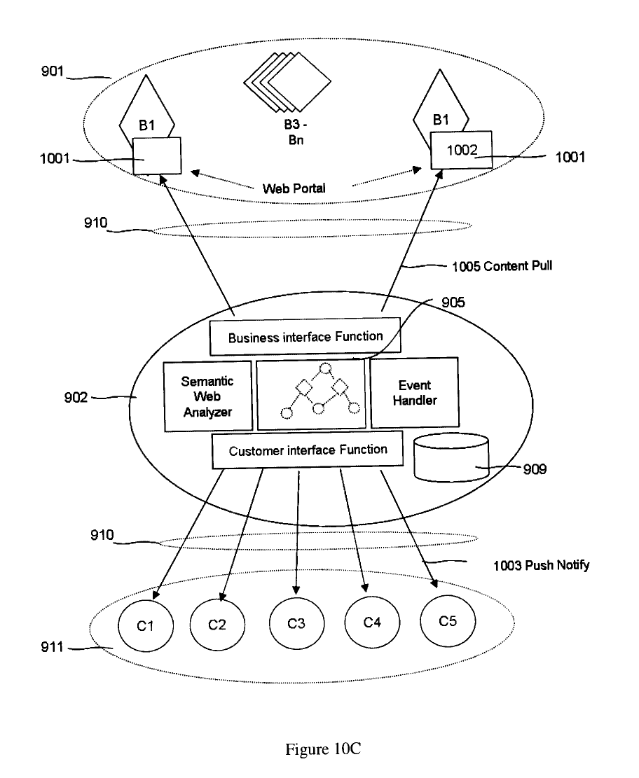

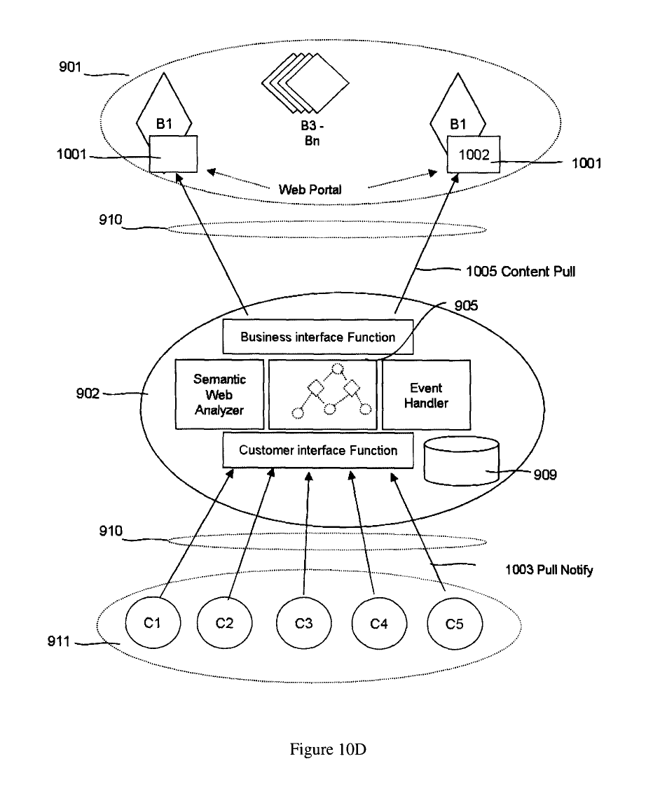

Now referring to FIG. 10A, an Event Manager having an event pushed from a business web site to a B2B2SC server and an event pushed towards a customer is depicted. A business' online website 1001 comprises content that includes metadata information such as semantic web tags or proprietary metadata information for business events, such as a campaign or promotion. When the new content or the event metadata is deployed to the online website 1001, the business deployment process invokes an event interface such as an API 1002 from the B2B2SC server 902.

Such event interface 1002 triggers the B2B2SC Event Manager to fetch content from a business web site 1000 and 1001 and the Semantic Web Analyzer to perform at least one semantic analysis to determine the content comprising metadata information.

Once the content is analyzed by the analyzer, the B2B2SC server 902 invokes the Event Rule Engine to personalize the event information. For example, in the case of a promotional event, the Event Rule Engine may assign additional benefits, such as additional promotions, based on shopping habits, age, sex or any other parameter.

The event is forwarded to customers 911 members of the specific business community, using a push notification 1003, such as text message, HTML 5, proprietary push solutions such as Apple Push Notification Service or Android™ Cloud to Device Messaging (C2DM) or delivery through an IPTV system to the members

Now referring to FIG. 10B, an alternative flow to the FIG. 10A is presented. This flow shows an event forwarded to a customer 1004 using a pull notification such as periodical pull from a Mobile Device.

Now referring to FIG. 10C, a second alternative flow to the FIG. 10A is presented. This flow shows a B2B2SC Server configured to periodically monitor particular business websites. Upon expiration of the monitoring timer, a B2B2SC Event Manager pulls content from the business web site 1005 and performs a Semantic Event Analysis to determine if any event related content is present.

Now referring to FIG. 10D, an alternative flow to the FIG. 10C is presented. This flow shows the same process as in FIG. 10C but using a consumer notification such as presented in FIG. 10B

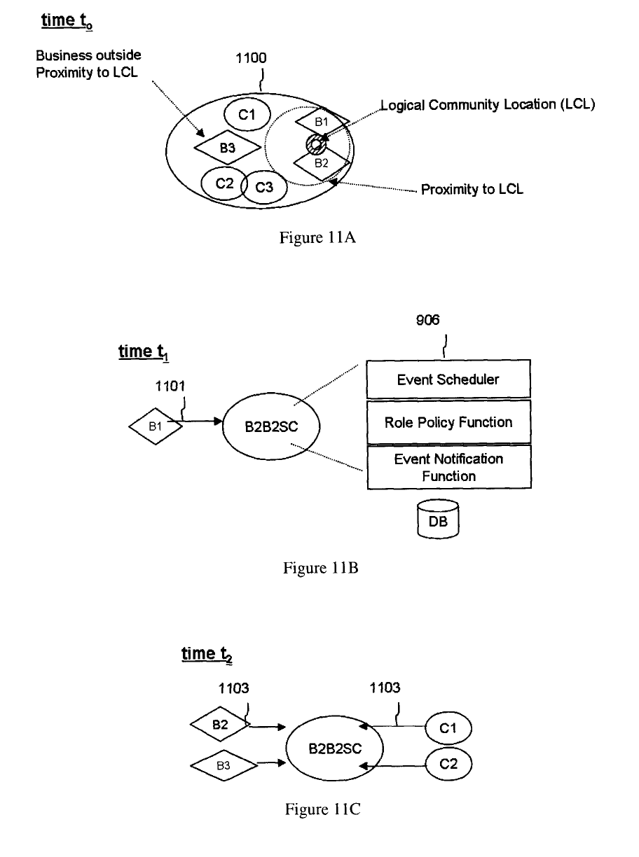

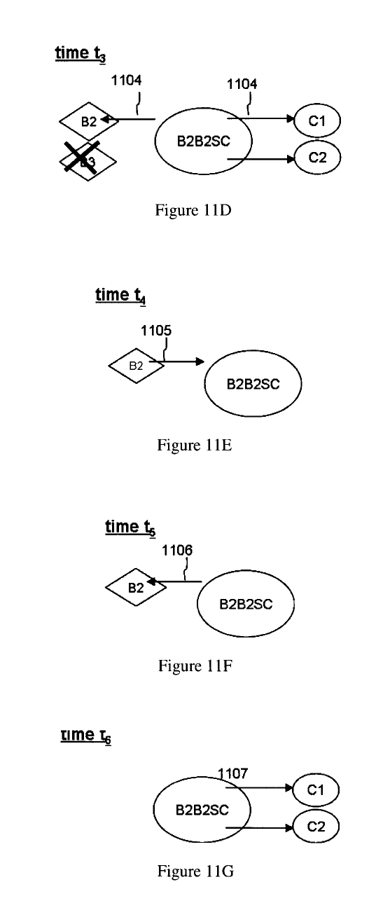

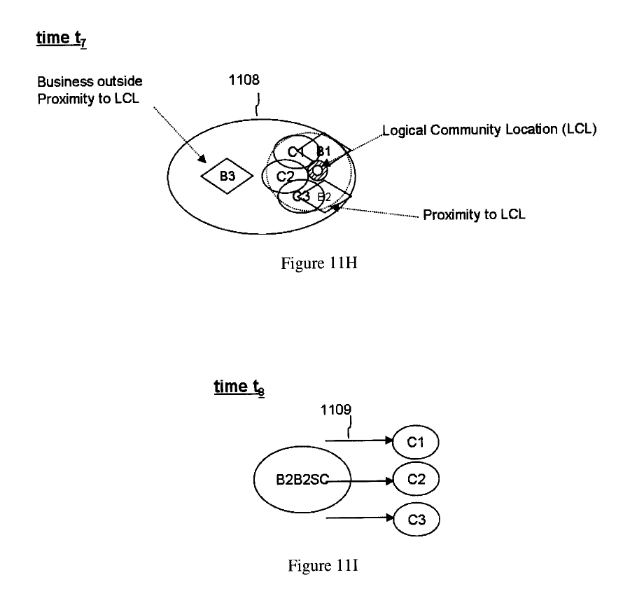

Referring now to FIGS. 11A to 11I, different diagrams on the principle and life span of a Social/Commercial Event Community are depicted.

In FIG. 11A, the area 1100 depicts the geographical layout of a Commercial Event Community at the time t₀. Businesses B1, B2, B3 are members of a B2B2SC system. Business B1 is organizing a commercial event at a future time and date t₇. The event will physically be held within a specific range of the business B1 premises.

Now, at time t₁, presented on the FIG. 11B, business B1 connects to a B2B2SC system through the Business Interface Function, and invokes an interface, such as API, within the Event Manager. As a consequence of the invocation of the interface, the B2B2SC server creates and configures a new Community of type Social/Business Event. In this example, a Business B1 provides its premises as the LCL for the event and a Business B2 is located within a specific range of the LCL while a business B3 is located outside the specific range of the LCL. An Event Manager creates the new Community and inserts a record containing the time t₇ in the Event Scheduler. The Rule Policy Function assigns business B1 as the owner of the Community and applies at least one default policy for Communities of Social/Commercial Events. The default policy allows any business located within the range of this specific LCL to claim the role Community Provider, allowing the business to forward business promotions to the Community before, during and after the Social/Commercial event.

Now referring at FIG. 11C, at time t₂, the businesses B2 and B3 and the customers C1 and C2 register to the B2B2SC server and claim the role Community Consumers. Upon the assignation, the customers start receiving updates from the community. The businesses B2 and B3 request the role Community Providers.

At time t₃, represented at FIG. 11D, the Rule Policy Function declines business B3 to join the community, since B3 does not fulfill the Rule Policies for this community. The policy requires that a business shall be located within the range of the LCL. Business B2 being located within the specified range, the B2B2SC server assigns to the business the role Community Provider. At this moment only, the B2B2SC server assigns to the customers C1 and C2 the role Community Consumers.

At time t₄, depicted at FIG. 11E, a business B2 invokes an interface, such as an API, within the event manager. The invocation propagates to the Community that B2 has promotional information to share the community members. The B2B2SC system fetches information from B2 web portal using the Semantic Web procedure as described in FIG. 10A. At time t₆, presented at FIG. 11G, and following a request, a promotion may be is forwarded to all customers C1 and C2.

Now referring to FIG. 11H, the social event is taking place at time t₇. At this moment, customers C1, C2 and C3 are physically attending the event. A customer C1 is a member of the B2B2SC system and has not joined the Social/Commercial Event. Since the customer C1 is located within the range of the LCL, the Event Rule Function temporarily assigns C1 as a member of the community. Then, the B2B2SC system allows the customer C1 to receive business promotions from businesses B1 and B2 during the Social/Commercial event.

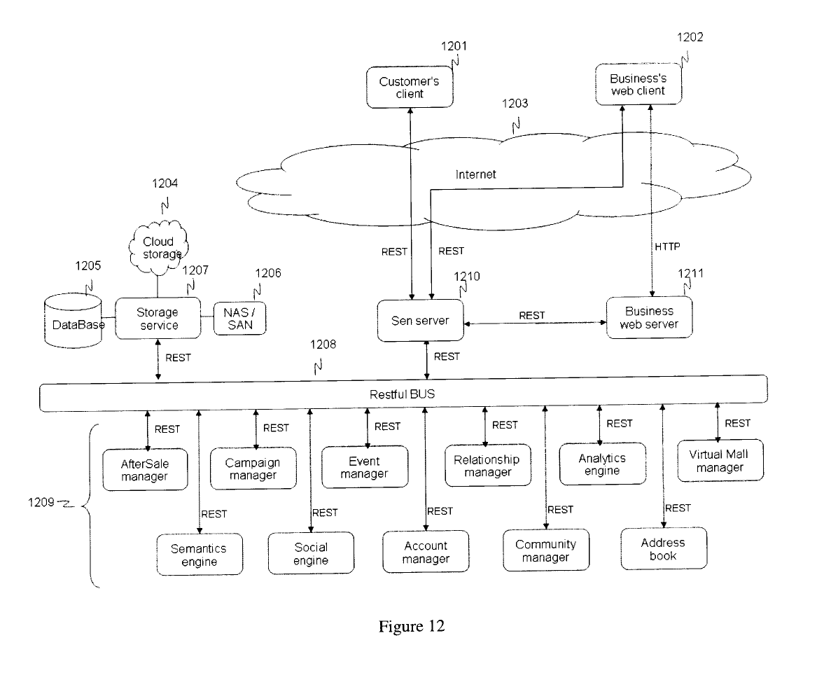

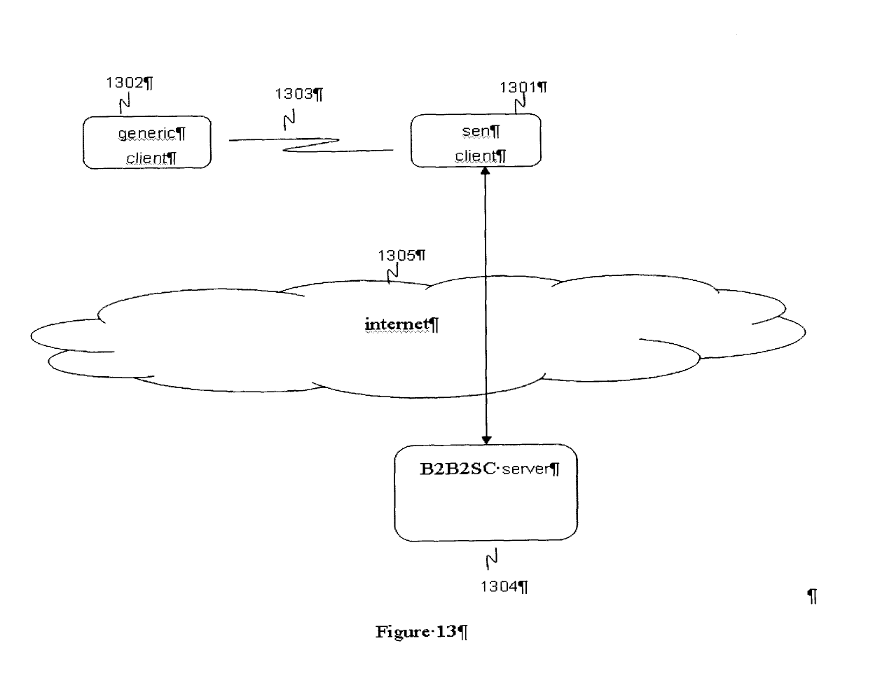

Referring to FIG. 12, an architectural view of the B2B2SC system is presented. A client device 1201 is connecting to the B2B2SC system through the B2B2SC server 1210. These client devices 1201 are typically used by the community members. A business client device 1202, such as a web browser, a smart phone device or other similar device connects to B2B2SC system through a web server 1211. The web server 1211 represents the businesses' tool that manages their communities and that uses the different components of the B2B2SC system to reach and offer services 1209 to their communities. The B2B2SC system comprises a restful bus 1208 that links the different modules/components together. Other technologies may be used to link such modules/components. The components communicates together using a restful protocol. Such communication process allows the B2B2SC system to be modular as every module could be scaled separately. Naturally, one can choose to run all these modules in a single process. The B2B2SC system comprises a storage service 1207 which abstracts the storage type, which can be a database 1205, a cloud storage 1204, a NAS/SAN 1206 or any other storage mean.

Now referring to FIGS. 9 and 13, a second embodiment of the present system and method is shown. The client device 1301 is used as a relay by another system 1302 in a machine to machine mode (M2M). As example, an on-board diagnostics system of a vehicle may communicate 1303 with the client software running on the customer's mobile device. The SEN client 1301 acts as a relay and the system 1302 (machine) uses the client 1201 as a relay. This SEN client 1301 start being used as a relay when a customer holding the device which is running the client 1201 enters a vehicle or is located in a certain range of the vehicle. The system may communicate its current status to the client using wireless technology, such as Bluetooth or Wi-Fi. Then, the client determines an event to be scheduled, such as car maintenance, within the customer's business community event manager. The condition to create such an event could be specified by the business offering the maintenance service in the event rule function of the event manager 906.

Such a machine to machine communication may be extended to any system. For example a heart monitor device communicating through the client the registered readings to the patient's community that is centered for example around a clinic or a doctor (here the patient is the customer and the business is the clinic or the doctor which the patient joined).

Another example can be in gaming community, where points, results, community gaming are relayed from the mobile device to another client through machine to machine protocols and the communication is extended back to the SEN.

In essence, any SEN community member(s) can use their client as a relaying device through machine to machine protocols to extend the community communication and therefore creating a new/extended social network.

The following sections present the different aspects of the invention from a customer and business point of views.

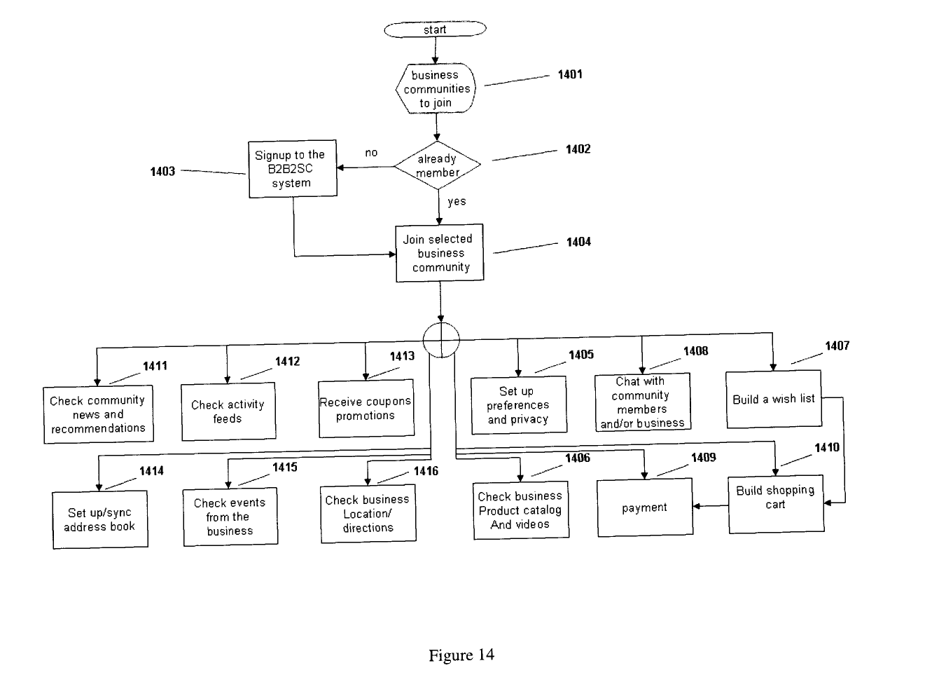

Now referring to FIG. 14, a typical customer member application flow is presented. First, the customer must install the application on his device, such as a smart phone. Then, the application will display a list of the available communities part of the B2B2SC system, also called SEN system, that are located within a range from the geographical location of the customer position 1401. The customer must select the candidate community to join. If the customer is already member of the B2B2SC system 1402, he must complete the step of joining the business community 1404. In the event where he is not a member of the B2B2SC system, he must complete the signup process 1403. Once the customer has joined community, a plurality of functions may be executed by the customer from the application. As example, such function may be setting up the preferences and privacy of the membership 1405, accessing business product catalog 1406, creating a wish list or a shopping cart (or move items from one to the other) 1407. Also, a customer may engage a conversation with the business through chat (or video chat), or with other members of the community 1408. Additionally, the customer may use the B2B2SC system to perform his payments 1409, making the B2B2SC system a one place to browse products, create carts 1410, proceed with payments, chat with business regarding purchased product or any other related matter and keep aftersale information on the system such as warranties. The application also provides function for a customer to receive coupons and promotions 1413, to set up and to synchronize an address book 1414 and to consult the news and recommendations from the community 1411, the activity feeds 1412, the events organized by the business or community 1415 and the business location or driving directions 1416.

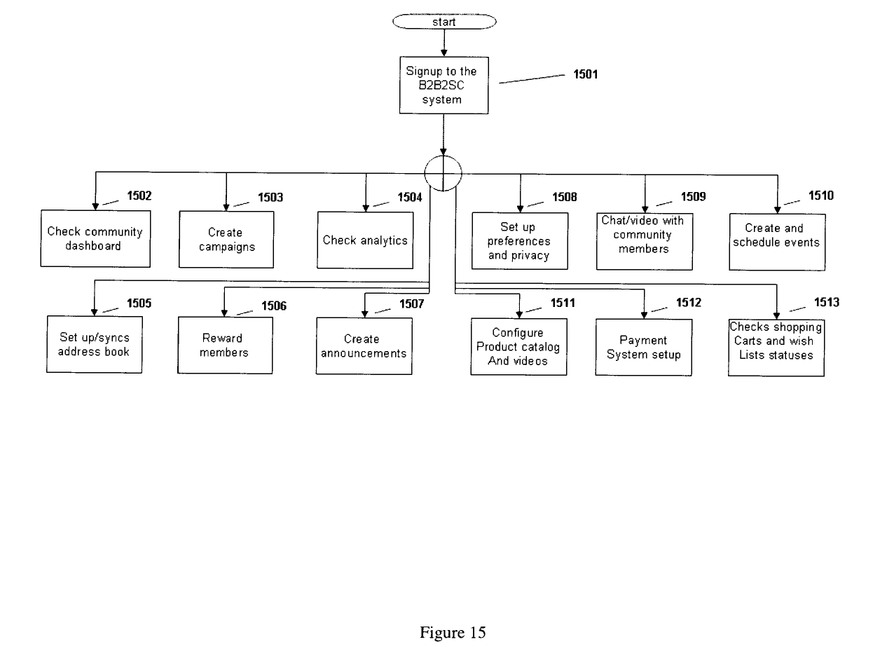

Referring now to FIG. 15, an example of a business flow is shown. Businesses become members of the B2B2SC system by signing up to the system 1501. Once the signing up process 1501 is completed, a plurality of functions may be executed by the businesses, such as setting up preferences and privacy 1508, using the customer dashboard 1502, such dashboard displaying the community members and the presence of such members within the a specific range of the business location. Businesses can also create campaigns 1503, such as sending up coupons and promotions to community members. Different target groups may be created. Other features available to the businesses of the application include consulting analytics 1504, creating or scheduling events 1510, configuring the available product catalogs and videos 1511, setting up payment system 1512 and consulting the different shopping cards and wish lists 1513. The application also provides function for a business to set up and synchronize an address book 1505, reward members 1506, create and publish announcements 1507 and chat or communicate through video-conference with members 1509.

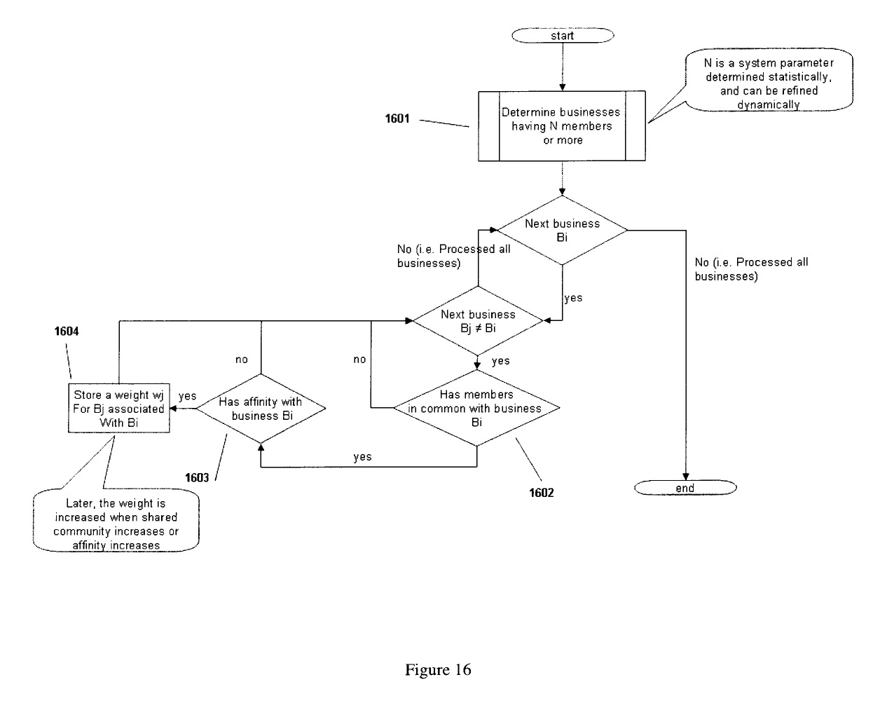

Referring now to FIG. 16, an example of a method to determine a virtual relationship between two or more businesses is shown. A first step may be to identify the businesses having a certain community mass 1601, as an example, being greater than N members. Then, for a certain business Bi, the system identifies the business Bj sharing a specific number of members 1602, in this example M, being a system parameter, with Bi and also having at least one affinity with Bi 1603. Such affinity may refer to the fact that Bi and Bj are not competitors. Another affinity could be a common geographical area, or a common traffic axis. Once the two conditions are met, a number is associated to the related businesses 1604, in this case Bi and Bj. Such number represents a weight of a virtual relationship, referred earlier in this document as an index. This weight is a function of the number of members in the shared community and the affinity criteria between the related businesses. Finally, the B2B2SC system updates this weight accordingly.

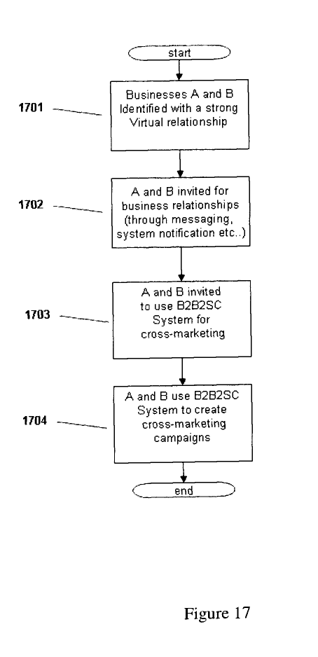

Referring now to FIG. 17, an example of the method of notifying a business is presented. In the event where a very strong virtual relationship exists between two or more businesses 1701, being a virtual relationship having a very high weight, the B2B2SC system notifies the related businesses by means of messaging 1702, such as SMS, email, MMS or any other messaging mean by showing a notification to the businesses through an application or by directly contacting by phone or other means the businesses. Such businesses are informed of the potential relationship existing between them. The system invites the businesses to establish a contact and a relationship 1703. Also, the B2B2SC system invites the businesses to use the system to enforce this relationship 1704, such as creating cross-marketing campaigns.

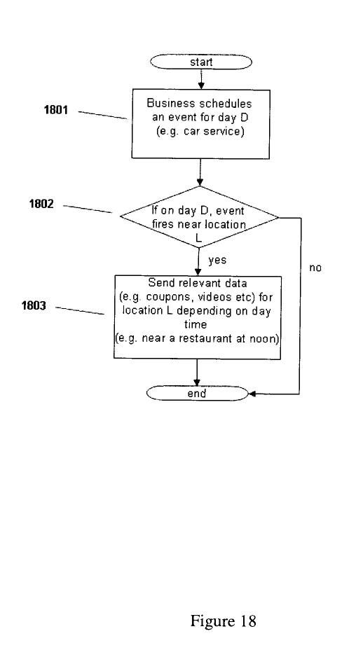

Now referring to FIG. 18, an example a usage of the event manager is shown. In this example, a business having set up and scheduled an event for a certain customer, such as an appointment for car service in 3 months, should be considered 1801. When the event is about to expire, the system identifies the location of the customer, the time of the day and if specific rules have been set up for the event 1802. For example, the business may set up this rule: “At the day of the appointment of the customer is near a restaurant and it's around noon, I (the business) want to offer my customer a coupon for a specific restaurant”. When the event occurs, the B2B2SC system sends the relevant data to the customer device, such data being ready to be used and consumed.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A system for sharing business communities, the system comprising:
a) at least one server:
i) configured to store communities of entities;
ii) configured to allow the sharing of communities between entities;
iii) configured to allow the creation of at least one relationship between at least two communities of entities;
b) at least one storage service configured to persist communities of entities;
c) at least one manager configured to manage entities.

2. The system for sharing business communities according to claim 1, wherein the system is configured as a sensor network.

3. The system for sharing business communities according to claim 1, wherein the at least one manager is an account manager.

4. The system for sharing business communities according to claim 1, wherein the at least one manager is a community manager

5. The system for sharing business communities according to claim 1, wherein the at least one manager is a social engine

6. The system for sharing business communities according to claim 1, wherein the at least one manager is an analytics engine.

7. The system for sharing business communities according to claim 1, wherein the at least one manager is an address book, wherein the address book allows each entity of the system to define and import information related to such entity contacts.

8. The system for sharing business communities according to claim 1, wherein the at least one manager is an event manager, wherein the event manager allows at least one of the entities to schedule events for at least one of the communities.

9. The system for sharing business communities according to claim 1, wherein the at least one manager is an event manager, wherein the event manager allows at least one of the entities to schedule events to entities separated by n-degrees of separation.

10. The system for sharing business communities according to claim 1, wherein the at least one manager is a reward manager, wherein the reward manager provides rewards to the entities based on patterns of activities of the entities within the system.

11. The system for sharing business communities according to claim 1, wherein the at least one manager is a campaign manager, wherein the campaign manager allows at least one of the entities to create and parameterize at least one marketing campaign, the at least one marketing campaign comprising a method to reach at least one of the communities using at least one incentive.

12. The system for sharing business communities according to claim 1, wherein the at least one manager is a relationship manager, wherein the relationship manager evaluates and defines the relationships between the entities using the entities shared communities and relationships existing between at least two community entities and their respective address books.

13. The system for sharing business communities according to claim 1, wherein the at least one manager is an after sale manager, wherein the after sale manager allows at least one of the entities to provide after sale service for the entity community members by handling customer care information.

14. A method for creating at least one virtual relationship between at least two community owner entities, the method comprising:
a) analyzing a data source to identify potential virtual relationships between related community owner entities;
b) communicating the identified potential virtual relationships to the related community owner entities;
c) displaying the identified potential virtual relationships to the related community owner entities;
d) allowing the related community owner entities to join the identified potential virtual relationships;
e) if needed, requesting an approbation by the community owner entity before another entity may join a virtual relationship;
f) creating such virtual relationship within a system, wherein the virtual relationship is either shared unilaterally or bilaterally between the requesting community owner entity and the other community owner entity.

15. A system for sharing business communities, the system comprising:
a) at least one server, wherein the at least one server is configured to store communities of entities;
b) at least one client, wherein the at least one client is configured to communicate with the server.

16. The system for sharing business communities according to claim 15, wherein the at least one client acts as a relay for another system through a machine to machine interface.

17. A system for creating virtual relationship with entities of shared communities being part of the system, the system comprising:
a) at least one server:
i) configured to store communities of entities;
ii) configured to allow the sharing of communities between the entities;
iii) configured to allow the creation of at least one virtual relationship between at least two communities of entities.
b) at least one storage service, wherein the at least one storage service is configured to persist at least one virtual relationship.

18. The system for creating virtual relationship according to claim 17, wherein the at least one virtual relationship is a geographical relationship, wherein the relationship is characterized by an entity located within the geographical area covered by a community of entities.

19. The system for creating virtual relationship according to claim 17, wherein the at least one virtual relationship is a critical mass of customers, wherein such critical mass represents the minimal number of entities having shopped at two or more community owner entities.

20. The system for creating virtual relationship according to claim 17, wherein the at least one virtual relationship is an event relationship, wherein the relationship represents an event that may be either recurrent or punctual in time.

21. The system for creating virtual relationship according to claim 17, wherein the at least one relationship is an activity relationship, wherein the relationship represents a habit of an entity.

22. The system for creating virtual relationship according to claim 17, wherein the at least one virtual relationship is a path pattern relationship, wherein the relationship represents the usual itinerary or path of an entity.

23. The system for creating virtual relationship according to claim 17, wherein the at least one virtual relationship is a bidirectional relationship, wherein the relationship represents an alliance between at least two community owner entities.

24. The system for creating virtual relationship according to claim 17, wherein the at least one virtual relationship is a unidirectional relationship, wherein the relationship represents an association between at least two community owner entities, and allows only one community owner entity to push promotions to member entities of at least one community owned by another community owner entity.

25. The system for creating virtual relationship according to claim 17, wherein the at least one server is being part of a network of devices and wherein such devices comprise software or hardware compatible with the server.

26. The system for creating virtual relationship according to claim 17, wherein the at least one server comprises at least one business interface module, wherein the module comprises:
a) at least one web portal sub-module, wherein the web portal sub-module provides tools to manage at least one community of entities;
b) at least one event notification sub-module, wherein the event notification sub-module allows the server to notify a community entity of the occurrence of at least one event;
c) at least one interface sub module between an entity domain and the server, wherein such entity domain comprises at least one entity registered with the server and wherein such module allows an entity to interface with the server.

27. The system for creating virtual relationship according to claim 17, wherein the at least one server comprises at least one event manager, wherein the manager allows an entity to schedule events to entities separated by n-degrees of separation.

28. The system for creating virtual relationship according to claim 17, wherein the at least one server comprises at least one community module, wherein the module enables any entity to register to at least one community and subscribe to at least one event from the community.

29. The system for creating virtual relationship according to claim 17, wherein the at least one server comprises at least one analytic module, wherein the module identifies and extracts possible relationships between entities members of the communities stored within the server; and exposes the relationships to the related community owners.

30. The system for creating virtual relationship according to claim 17, wherein the at least one server comprises at least one customer interface module, wherein the module allows a customer entity to interface with the server.

31. The system for creating virtual relationship according to claim 17, wherein the at least one server comprises at least one business to business to shared communities module, wherein the module manages the relationship between entities and the community joined by such entities.

32. A method for registering and assigning a role to a business community, wherein such method comprising:
a) creating a business community comprising the registering business entity;
b) storing the geographical range of the business community within the system;
c) assigning at least one role to the registering business, wherein the role being community owner, community provider or both;
d) allowing at least one customer entity to join the community.

33. The method for registering and assigning a role to a business community according to claim 32, wherein the method comprises creating the community through a business interface function and invoking an interface within an event manager.

34. A system for sharing business communities, the system comprising:
a) at least one server:
i) configured to store communities of entities;
ii) configured to allow the sharing of communities between entities;
iii) configured to allow the creation of at least one relationship between at least two communities of entities;
b) at least one storage service configured to persist communities of entities;
c) at least one event manager business interface function, wherein the event manager function comprises an event rule engine component, the event rule engine enabling the system to provide enhanced and personalized benefits and promotions to at least one individual entity within at least one community of entities.

35. The system for sharing business communities according to claim 34, wherein the at least one server comprises at least one semantic web analyzer, wherein the web analyzer analyzes web content looking for semantic metadata related to events existing on the server.

36. The system for sharing business communities according to claim 34, wherein the at least one server comprises at least one business to business to shared communities function, wherein the function allows at least one entity to register a community identity and to subscribe to at least on event provided by at least one community.

37. The system for sharing business communities according to claim 30, wherein the at least one server comprises at least interface function, wherein the function enables at least one device of an entity to interface with the server.

38. A method for a customer entity to join and use at least one business community, the method comprising:
a) the customer installing a client application on a device;
b) the application displaying a list of available communities located within a specific range of the geographical location of the customer position;
c) the customer selecting one or more community from the displayed list;
d) if not already a member of the system, the customer registering to the system;
e) if already a member of the system, the customer authenticating to the system;
f) the system adding the community to the list of joined communities of the customer;
g) the customer executing at least one function available through the application.

39. The method for a customer entity to join and use a business community according to claim 38, wherein the function allows the customer to set up the preferences and privacy of the membership.

40. The method for a customer entity to join and use a business community according to claim 38, wherein the function allows the customer to access at least one business product catalogue.

41. The method for a customer entity to join and use a business community according to claim 38, wherein the function allows the customer to create or manage a wish list or a shopping cart.

42. The method for a customer entity to join and use a business community according to claim 38, wherein the function allows the customer to engage in a conversation, through live communication means, with other members of the community or with the community entity owner.

43. The method for a customer entity to join and use a business community according to claim 38, wherein the function allows the customer to perform payments.

44. The method for a customer entity to join and use a business community according to claim 38, wherein the function allows the customer to set up or synchronize an address book.

45. The method for a customer entity to join and use a business community according to claim 38, wherein the function allows the customer to receive coupons and/or promotions.

46. The method for a customer entity to join and use a business community according to claim 38, wherein the function allows the customer to consult at least one of the following information:
a) the news and recommendations from the community members;
b) the activity feeds from the community;
c) the events organized by the community entity owner or community members;
d) the community owner location or driving directions.

47. A method for a business entity to create and manage at least one business community, the method comprising:
a) the business entity installing a client application on a device;
b) the business entity registering or signing up to the system;
c) the business entity executing at least one function available through the application.

48. The method for a business entity to create and manage at least one business community according to claim 47, wherein the function allows the business entity to set up at least one preference and privacy parameter.

49. The method for a business entity to create and manage at least one business community according to claim 47, wherein the function allows the business entity to use a dashboard.

50. The method for a business entity to create and manage at least one business community according to claim 47, wherein the function allows the business entity to create or manage at least one campaign.

51. The method for a business entity to create and manage at least one business community according to claim 47, wherein the function allows the business entity to consult analytics data.

52. The method for a business entity to create and manage at least one business community according to claim 47, wherein the function allows the business entity to create or schedule at least one event within at least one community.

53. The method for a business entity to create and manage at least one business community according to claim 47, wherein the function allows the business entity to consult analytics data.

54. The method for a business entity to create and manage at least one business community according to claim 47, wherein the function allows the business entity to create or manage at least one product catalogue or video.

55. The method for a business entity to create and manage at least one business community according to claim 47, wherein the function allows the business entity to set up a payment system.

56. The method for a business entity to create and manage at least one business community according to claim 47, wherein the function allows the business entity to consult at least one shopping cart or wish list.

57. The method for a business entity to create and manage at least one business community according to claim 47, wherein the function allows the business entity to set up and synchronize an address book.

58. The method for a business entity to create and manage at least one business community according to claim 47, wherein the function allows the business entity to reward at least one member of a community.

59. The method for a business entity to create and manage at least one business community according to claim 47, wherein the function allows the business entity to create and publish announcements.

60. The method for a business entity to create and manage at least one business community according to claim 47, wherein the function allows the business entity to communicate with at least one community member.

61. A method for identifying at least one virtual relationship between at least two business entities, the method comprising:
a) identifying the business entities having a certain community mass;
b) identifying the business entities from the identified entities having at least one common member with another business entity from the identified entities and having at least one affinity with the another entity;
c) assigning a weight to the virtual relationship based on the number of affinity and the number of common members;
d) updating the weigh of the relationship within the system.

62. The method for identifying at least one virtual relationship between at least two business entities, according to claim 61, wherein the at least one affinity represent the fact that both the entities are not competitors.

63. The method for identifying at least one virtual relationship between at least two business entities, according to claim 61, wherein the at least one affinity represent the fact that both the entities cover a common geographical area or have a common traffic axis.

64. A method for notifying a business entity, the method comprising:
a) identifying the business entities within a system having a very strong virtual relationship, wherein a very strong virtual relationship is a relationship having a weigh number being higher or equal to a specific trigger number;
b) identifying the business entities from the identified entities having at least one common member with another business entity from the identified entities and having at least one affinity with the another entity;
c) notifying the identified business entities;
d) through the notification, inviting the business entities to establish a contact, a relationship and/or to enforce at least one existing relationship.

65. A method using an event manager, the method comprising:
a) a business entity configuring and scheduling a time of an event for a customer entity;
b) adding a specific rule to the event;
c) at the scheduled time and when the rule is rendered, identifying the location of the customer entity;
d) sending data associated with the event to the customer device.

66. A system for creating virtual malls, the system comprising:
a) at least one server:
i) configured to store communities of entities;
ii) configured to allow the sharing of communities between entities;
iii) configured to allow the creation of at least one relationship between at least two communities of entities;
b) at least one storage service configured to persist communities of entities;
c) at least one virtual mall manager.

67. The system for creating virtual malls according to claim 66, wherein the at least one virtual mall is defined by the virtual mall manager based on a shared community between two or more businesses.

68. The system for creating virtual malls according to claim 66, wherein the at least one virtual mall is defined by the virtual mall manager based on customer selection of businesses.

69. The system for creating virtual malls according to claim 66, wherein the at least one customer is upgraded to a business account by the virtual mall manager, based on the customers preference to engage his social links to extend the virtual mall customer base.
